(19) United States
(12) Patent Application Publication
(10) Pub. No.: US 2010/0240458 A1
(43) Pub. Date: Sep. 23, 2010

(54) VIDEO GAME HARDWARE SYSTEMS AND SOFTWARE METHODS USING ELECTROENCEPHALOGROPHY

(75) Inventors: Andrea Gaiba, Padova (IT); Davide Squarise, San Giorgio delle Pertiche(PD) (IT); Lorenzo Godina, Casteggio(PV) (IT)

Correspondence Address: BANNER & WITCOFF, LTD., 1100 13th STREET, N.W., SUITE 1200, WASHINGTON, DC, 20005-4051, US

(73) Assignee: PUB COMPANY S.R.L., Albignasego (IT)

(21) Appl. No.: 12/728,806

(22) Filed: Mar. 22, 2010

Related U.S. Application Data
(60) Provisional application No. 61/161,914, filed on Mar. 20, 2009.

(51) Int. Cl. A63F 13/02

(52) U.S. Cl. 463/36

(57) ABSTRACT

A player's mental attributes may be determined and used in interacting with video games or training programs through a video game system. The video game system may include a biometric controller such as an EEG device or configured to detect a level of attention and a level of relaxation of the player through electrical impulses exhibited by a player's brain and/or pulse oximetry monitoring device. These determined levels of attention and relaxation may be interpreted by the video game system into one or more actions in or changes to a video game environment. Additionally or alternatively, video games may be used to train a player to lower stress and improve concentration or focus. The games may be entertainment based or non-entertainment related (e.g., instructional/exercise focused). Further, combinations of controllers may be used to control various aspects of a video game or training program to exercise both body and mind.

### CROSS REFERENCE TO RELATED APPLICATION

This application is a non-provisional application of and claims the benefit of priority from U.S. Provisional Application Ser. No. 61/161,914, entitled “Video Game Hardware Systems and Software Methods Using Electroencephalogrophy,” filed Mar. 20, 2009.

### BACKGROUND

Many video games today are purely directed toward entertaining the player and providing an immersive gaming experience. Accordingly, in some instances, the games may create a very real sense of urgency, panic or excitement among a host of other emotions which, while entertaining, may increase stress levels. Even when many of these games help a player reduce stress levels, this result is generally a secondary goal of the game and often fails to provide the player with any knowledge of how to better control his or her stress. Indeed, without devices, controllers and/or software that are configured to measure a player's level of stress, it may be difficult to integrate a stress-relief focus into a video game.

Traditional stress relief methods, on the other hand, such as breathing exercises, meditation and the like often involve physical or mental activities that often lack entertainment value. As such, individuals may view these exercises as tasks or work and thus, might not be as inclined to engage in such activities. Without relaxation training, the individual may carry heightened and unhealthy levels of stress for longer periods of time.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects of the present disclosure relate to a physical and mental training system that helps a user control his or her stress level and focus. For example, a physical and mental relaxation training system may include a variety of training programs configured to take a player through one or more exercises designed to reduce the user's level of stress and increase relaxation. The system may further include entertainment programs or games that use relaxation and attention as parameters to control elements within the game. In one example, a player may be required to guide an avatar across a tightrope. Accordingly, the system may measure a level of relaxation and/or attention associated with the player to determine whether the avatar is able to make it across the tightrope and a speed with which the avatar moves. Using the above example systems and methods, a player may consciously control and affect his or her relaxation and focus while being entertainment by elements of the video game.

According to another aspect, a video game or training system may include a controller configured to detect one or more physical or mental attributes of a player that correlates to the player's level of anxiety, stress, relaxation and/or focus. For example, the system may include an electroencephalograph controller that is configured to detect electrical impulses generated by the brain. In other examples, the system may include a heart rate monitor or a blood pressure monitor or a blood oxygen saturation monitor or any other device able to measure and monitor biomedical and biometrical parameters such as (but not limited to) breathing, pulse and eyes blinking. In yet other examples, the system may include a temperature monitor. Accordingly, instead of or in addition to using physical actions to control elements of a game, a player may progress through a game or training program using passive physical and mental attributes such as heart rate and brain waves.

According to another aspect, a video game may receive control input through multiple control devices including a passive input device and an active input device. In one or more arrangements, these input devices may be coupled or otherwise connected (wired or wirelessly) to one another to affect operation of each other. For example, active input received through an active input device may alter the type of data detected by the passive input device. In another example, a passive device may communicate with a game console through the active input device.

According to another aspect, a video game system or method may automatically generate a training program designed to help alleviate stress and increase relaxation of a player. The training program may be automatically generated based on a variety of factors including current statistics for the player, preferences (e.g., in terms of exercises and/or games), available control devices and the like. The player may also be provided the option of customizing the program once it has been generated. In other arrangements, multiple pre-defined training programs may be offered to the player for use or customization. For example, physical training programs may include an active program, a relax program, a balanced program, a body control program and a kids program. Mental training programs, on the other hand, may include mental stability training, mental growth training, mental strength training and kids training.

According to yet another aspect, available options, training programs, games and the like may depend on the type of profile that is selected by a player. For example, if a player selects a guest profile, the player might not be able to select multi-day training program. Instead, the player might only be allowed to select one day or one session training programs.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment and hardware devices in which various aspects of the disclosure may be used.

FIG. 2 illustrates an example video game console and associated controller devices according to one or more aspects described herein.

FIG. 3 is a flowchart illustrating an example method for initiating a relaxation video game and training program according to one or more aspects described herein.

FIG. 4 illustrates an example profile selection interface according to one or more aspects described herein.

FIG. 5 illustrates an example welcome page interface according to one or more aspects described herein.

FIG. 6 illustrates an example process flow generating a recommended training program according to one or more aspects described herein.

FIG. 7 illustrates an example training status graph configured to track a user's progress and projected progress according to one or more aspects described herein.

FIGS. 8A-8D illustrate example initial training tests that may be used for determining a user's attributes according to one or more aspects described herein.

FIG. 9 is a flowchart illustrating an example method for generating a processing input for a relaxation training test according to one or more aspects described herein.

FIG. 10 illustrates an example menu interface for selecting various relaxation training and entertainment options according to one or more aspects described herein.

FIG. 11 illustrates an example navigation flow for navigating through various training and entertainment features of a relaxation video game according to one or more aspects described herein.

FIG. 12 illustrates an example interface configured to display a summary of a player's training according to one or more aspects described herein.

FIG. 13 illustrates an example training program selection and customization interface according to one or more aspects described herein.

FIGS. 14 and 15 illustrate example training program customization interfaces according to one or more aspects described herein.

FIG. 16 illustrates a graph displaying a projected stress level of a player for each of a predefined training program and a player customized training program according to one or more aspects described herein.

FIGS. 19-21 illustrate example relaxation games and game interfaces.

FIG. 22 illustrates an example knowledge database interface through which a player may explore various topics.

FIG. 23 illustrates an example screensaver selection menu according to one or more aspects described herein.

FIGS. 24A and 24B illustrate various training disciplines for training a player's mind and body to relax according to one or more aspects described herein.

FIG. 25 illustrates an example progressive muscle relaxation interface according to one or more aspects described herein.

FIG. 26 illustrates an example autogenic training interface according to one or more aspects described herein.

FIG. 27 illustrates an example binaural beat training interface according to one or more aspects described herein.

FIG. 28 illustrates an example visualization interface configured to aid a player in focusing and relaxing.

FIG. 29 illustrates an example attention and relaxation control device according to one or more aspects described herein.

FIG. 30 is a flowchart illustrating an example method for monitoring and processing active and passive input in a video game environment according to one or more aspects described herein.

FIGS. 31A and 31B illustrate example interfaces for a superhero game according to one or more aspects described herein.

FIGS. 32A and 32B illustrate example interfaces for a stick pick-up game according to one or more aspects described herein.

FIG. 33 illustrates an example interface for a relaxation video game according to one or more aspects described herein.

FIG. 34 illustrates an example interface for a video game in which a player is instructed to find a particular character according to one or more aspects described herein.

FIGS. 35A and 35B illustrate example interfaces for a gravity game according to one or more aspects described herein.

FIG. 36 illustrates an example interface for a projectile throwing game according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

In addition, the following description includes one or more aspects that may be used alone or in combination with each other. For example, the electroencephalograph (EEG) headset or other devices such as a pulse oximeter which are used to measure and monitor relaxation and stress levels may be used with the below described games and software, or with other games and software. The headset or other devices configured to measure and monitor relaxation and stress levels may be used with any game console, computing device, server, digital video recorder (DVR), mobile device, networked device, etc. The individually described games may be playable with or without the EEG headset or other particular devices as described above, and may be played in different manners than specifically described. The below descriptions are for illustrative purposes to enable multiple embodiments of each invention contained herein. Applicant reserves the right to pursue each invention individually or in combination with one or more other inventions described herein.

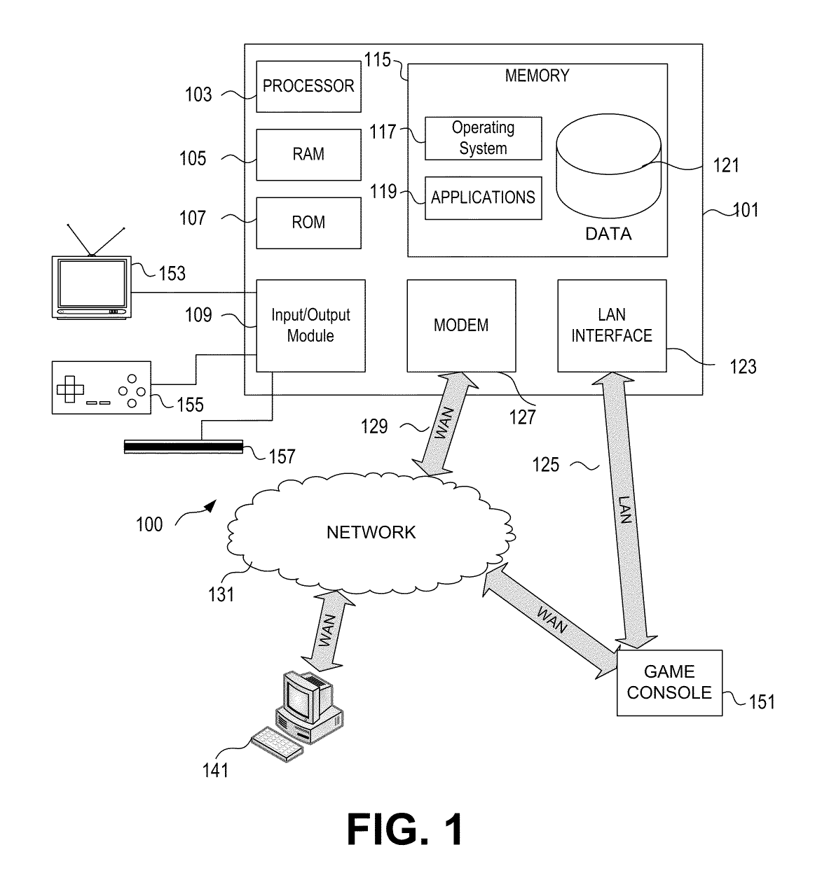

FIG. 1 illustrates a block diagram of a computing device 101 (e.g., a gaming console) in computing environment 100 that may be used according to an illustrative embodiment of the disclosure. The gaming device 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, video-camera, weight detection and control devices, pulse oximeter and/or stylus (or other input device(s)) through which a user of gaming device 101 may provide input, and may also include one or more of a speaker for providing audio output and a video display device for providing textual, audiovisual and/or graphical output. For example, I/O 109 may include one or more software and/or firmware adapters configured to enable communications with one or more input or output device such as display device 153 (e.g., a television), a game controller 155 and a motion sensor 157. Gaming device 101 may thus output images such as the movement of various elements of an electronic game on display device 153 based on and/or in response to the control input received through controller 155 and sensor 157 (e.g., depression buttons of controller 155 and movement detected by sensor 157). Software may be stored within memory 115 and/or other storage to provide instructions to processor 103 for enabling gaming device 101 to perform various functions. For example, memory 115 may store software used by the gaming device 101, such as an operating system 117, application programs 119, and an associated database 121. Alternatively, some or all of device 101 computer executable instructions may be embodied in hardware or firmware (not shown).

The gaming device 101 may operate in a networked environment supporting connections to one or more remote computers, such as terminals 141 and 151. The terminals 141 and 151 may be personal computers, gaming consoles or servers that include many or all of the elements described above relative to the gaming device 101. For example, gaming device 101 may be in network communication with gaming console 151, thereby allowing co-operative or competitive gaming between users of device 101 and console 151. The network connections depicted in FIG. 1 include a local area network (LAN) 125 and a wide area network (WAN) 129, but may also include other networks. When used in a LAN networking environment, the gaming device 101 may be connected to the LAN 125 through a network interface or adapter 123. When used in a WAN networking environment, the gaming device 101 may include a modem 127 or other network interface for establishing communications over the WAN 129, such as network 131. Network 131 may, for instance, comprise the Internet. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Gaming device 101 and/or terminals 141 or 151 may also comprise mobile terminals (e.g., mobile phones, PDAs, notebooks, etc.) including various other components, such as a battery, speaker, transceivers and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, gaming platforms, distributed computing/gaming environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

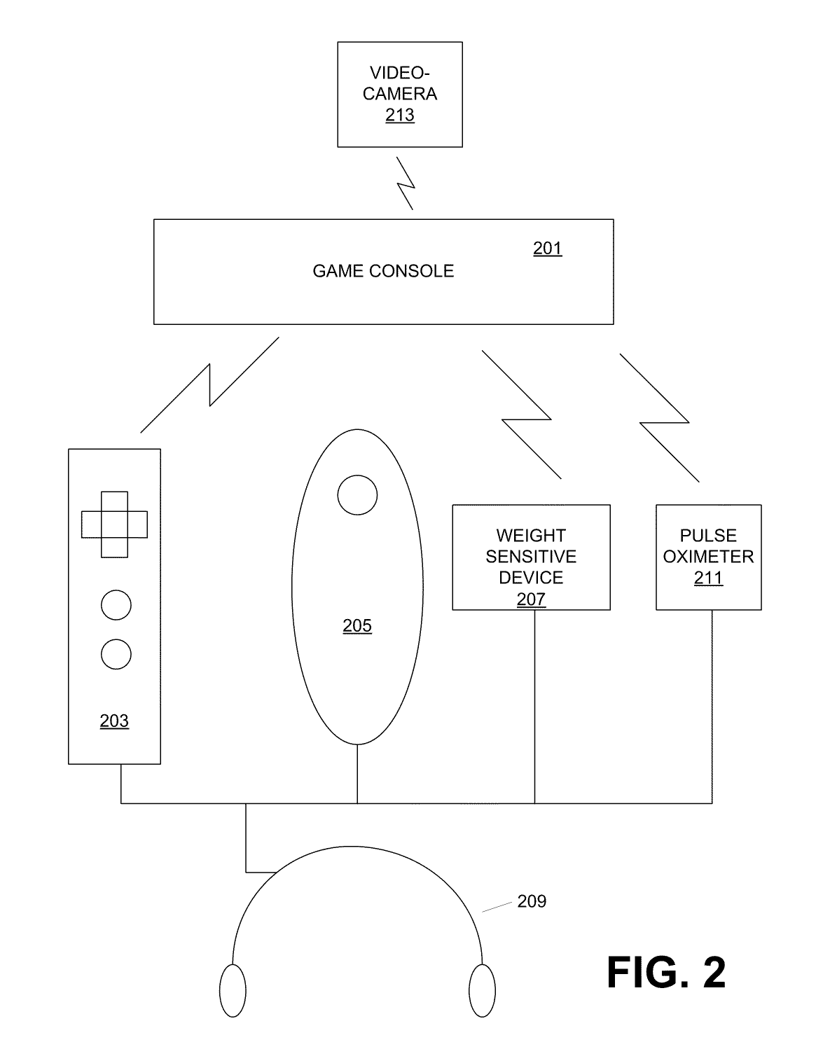

According to various aspects described herein, gaming console 101 may be used to play a video game that is directed to teaching a player how to control his or her levels of relaxation and focus/attention or any other parameters directly or indirectly related to stress and relaxation levels. In some examples, relaxation may require a player to be able to maintain proper control over his or her own mind and body. Accordingly, a relaxation video game may involve a series of tests, instructions and games configured to help the player achieve relaxation through better control of his physical and mental faculties. To detect a player's level of relaxation and control, various control and input devices may be used. FIG. 2 illustrates a gaming console 201 that may be wired or wirelessly connected to control/input devices 203, 205, 207 and 209. Control devices 203 and 205 may comprise a pair of handheld controls that may be coupled and/or otherwise connected to one another. In one example, control device 203 may be configured for use in one hand while control device 205 may be configured for use in the other hand, allowing console 201 and a game to detect motions of both hands of a player. Hand control devices 203 and 205 may include components configured to detect various types of input including hand motions and characteristics. For example, devices 203 and 205 may include multi-axis accelerometers to detect changes in orientation (e.g., rotation, tilt) of devices 203 and 205 and a motion sensor device (e.g., an infrared sensor tag) for tracking changes in position of devices 203 and 205. The connection between devices 203 and 205 may be wired or wireless and may allow device 205, for example, to communicate with console 201 if device 205 does not have its own communication capabilities. Alternatively or additionally, coupling or otherwise connecting devices 203 and 205 may allow changes or interactions of one device (e.g., device 203) to change or alter the operation of the other device (e.g., device 205).

Devices 207, 209, 211 and 213 may be configured to detect player attributes other than hand movements and orientation. For example, device 207 may comprise a board or platform upon which a user may stand or sit or perform other actions. Device 207 may include one or more weight sensors to determine shifts in weight, a user's level of balance, a position of a user's feet and the like. Accordingly, in one or more arrangements, device 207 may be used to determine a player's overall stability by determine a magnitude of any shifts in the player's weight. Device 209, on the other hand, may be configured to include a plurality of electrical sensors that detect electrical activity along a user's scalp produced by the firing of neurons within the brain. A player may thus wear such a device, e.g., device 209, on his or her head to allow his or her brain activity to be used as input in various training program and video game features and interactions. For example, a video game may translate a player's level of brain activity to a mental state (e.g., level of relaxation), which may then be used to control one or more elements of a game. Specifically, a video game may, in one or more examples, interpret a specific combination of brain frequencies to a high level of relaxation or a low level of relaxation. Additionally or alternatively, device 209 may also be coupled to a handheld controller such as device 203. The wired or wireless connection or coupling between devices 203 and 209 (and/or other devices 207 and 205) may be used to allow device 209 to communicate with console 101 and/or to affect the interpretation of data generated by and/or modify the operation of the other. For example, by coupling an EEG control device such as device 209 to a handheld control such as device 203, changes in the player's attention or focus may cause movements of control device 203 to be interpreted differently in a video game (e.g., an amount of actual movement of device 203 may translate to greater movement in the video game if the player loses attention or focus). Device 211 may be configured to measure and monitor the user's relaxation and/or stress levels (or any other physical and mental attributes and parameters of the user) through detection of the oxygen saturation in the user's blood. Moreover, devices 213 may be configured to measure and monitor the user's relaxation and/or stress levels (or any other physical and mental attributes and parameters of the user) through video detection and video capture of user's body and facial movements and state.

A video game, according to aspects described herein, may help a user reach a level of relaxation and/or physical fitness by initially testing a user's level of relaxation to determine a baseline set of player statistics and using various games and training features to help a player control his or her level of relaxation (e.g., by reducing stress). In one example, a relaxation video game may comprise a first menu that is used to greet the player and receive initial information. Once one or more tasks of the first menu has been completed, the player may be presented with a second menu that includes specific tasks, games, information and the like for achieving relaxation. Relaxation of body and mind may be treated or trained in different manners and thus, a video game may provide different activities, information and interactions for body and mind.

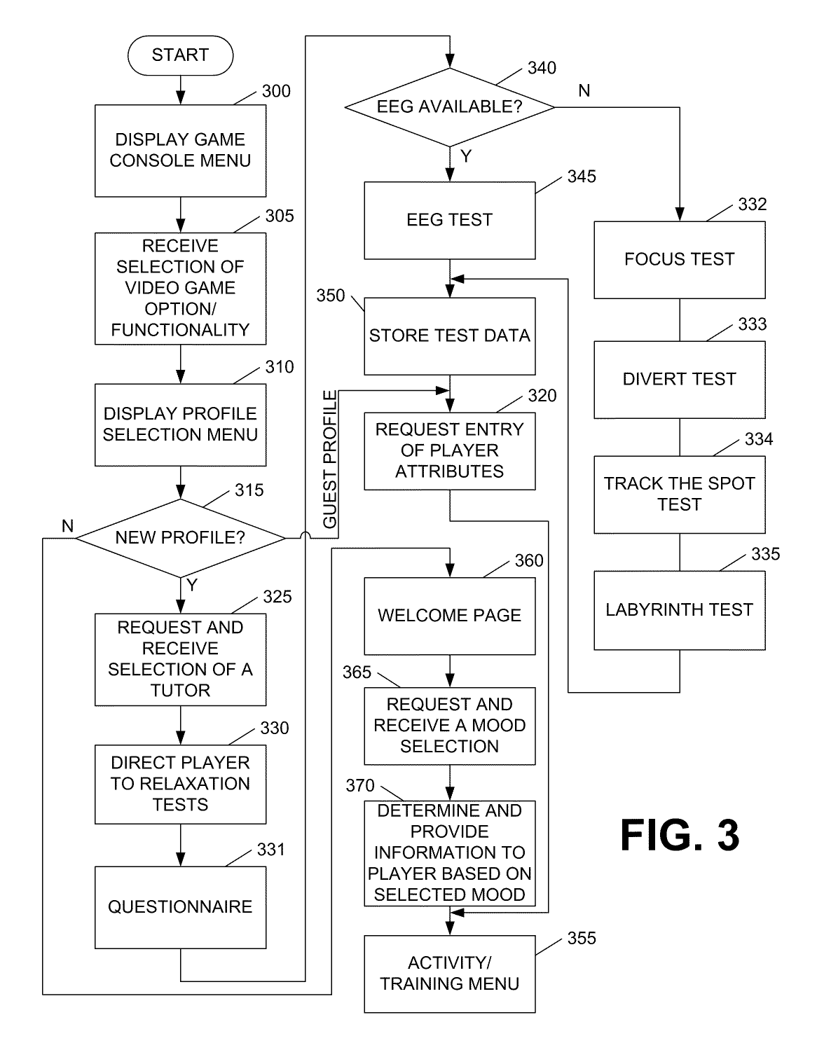

FIG. 3 is a flowchart illustrating a method by which a user may initiate a relaxation training video game. In step 300, a gaming system such as gaming device 101 of FIG. 1 may generate and display a console menu through which a player may select various games, functions and applications. For example, the menu may include movie playing functionality, video game playing functionality, an Internet browser application, a marketplace or store and the like. In step 305, the gaming system may receive a selection of a relaxation video game functionality from an input device such as controller 203 of FIG. 2. The video game functionality may correspond to a currently loaded video game or a plurality of available video games. In response to the selection, gaming system may display a profile selection menu for the relaxation video game in step 310. A player may select a previously saved profile or create a new profile from the profile selection menu. A profile may define various user characteristics such as name and/or appearance of an avatar. In one example, a user may select a predefined avatar or create a new avatar on a gaming system.

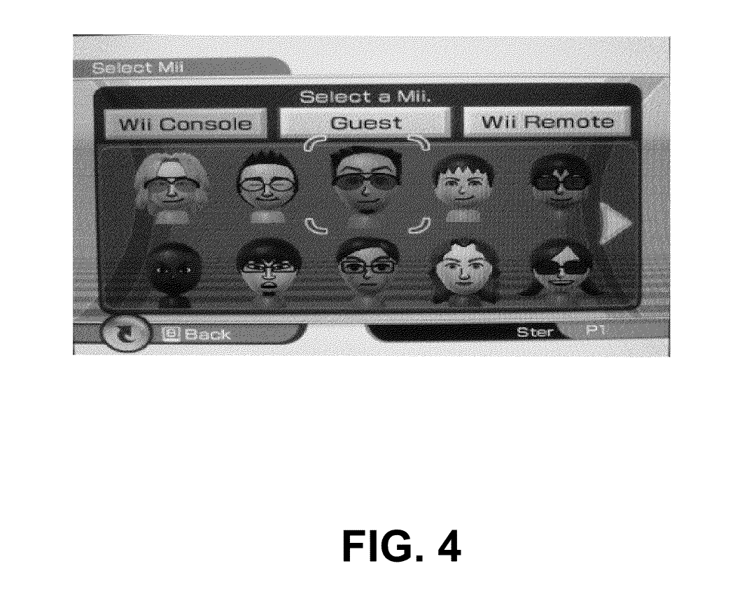

FIG. 4 illustrates an example profile selection menu in which multiple predefined avatars are displayed. If the player does not wish to choose an avatar or if the player's avatar is not listed, the player may choose to play as a guest instead. The guest avatar may be generic attributes and/or characteristics. An option (not shown) may also be provided where a user may create a new avatar. Alternatively or additionally, the creation of a new avatar may be performed through an alternate menu or interface.

Returning to FIG. 3, once a user has selected a profile, the video gaming system may determine whether the profile is a new profile in step 315. If so, the video gaming system may request and receive, in step 325, a selection of a tutor which may comprise a small animated character configured to guide and/or follow a player through the various games, exercises, training sessions and the like. For example, the tutor may be an object, an animal, a person and the like that reflects the player's mood and provides suggestions, hints, advice and other information during the games. Additionally, when the player has selected a new profile, the gaming system may direct the player to a relaxation test configured to determine an initial stress or relaxation level of the new profile in step 330. The relaxation test may include multiple components including a questionnaire (331), a diversion test/activity (332), a focus test/activity (333), a tracking activity/test (334) and a maze or labyrinth activity (335) or any other test which is used to assess the user's relaxation and stress levels. Activities 332-335 may be performed in any order and is not limited to the order shown in the figure. In one or more arrangements, the gaming system may, in step 340, initially determine whether an EEG or any other relaxation/stress measurement and monitor device is available prior to determining the tests and activities to provide to the player. If an EEG or any other relaxation/stress measurement and monitor device is available, the game system may select and provide an EEG test to the player in step 345. If, on the other hand, an EEG or any other relaxation/stress measurement and monitor device is not available, tests/activities 332-335 may be selected and provided instead. Questionnaire (331) might be provided in all instances (e.g., regardless of whether an EEG or any other relaxation/stress measurement and monitor device is available). Once the tests/activities have been completed, the game system may store the test/activity results in step 350. Text/activity results may include a measured status corresponding to a measured stress or relaxation level of the player. Once a user has completed the relaxation tests, the user (or profile) might not be required to perform the relaxation tests in the future. However, the player may be given the option to retake one or more of the tests if they so choose. In one arrangement, a player might not be allowed to retake the relaxation questionnaire.

After storing the test/activity results (in the case of new profiles) or if the player has selected a guest profile, the player may be asked to enter player attributes including weight, height, gender, number of times the player exercises and the like in step 320. In one example, the player may be asked to specify a training goal such as reaching a desired level of relaxation or improving a physical fitness level (e.g., desired resting heart rate, target number of push ups in 1 minute, strength, endurance, desired oxygen saturation level in blood, desired pulse and desired blood pressure). Physical fitness level may translate to a level of relaxation. In step 355, the game system may provide an activity/training menu to the player.

If, on the other hand, the selected profile is not a new or a guest profile (e.g., the user has selected a predefined profile), the gaming system may provide a welcome page to the player in step 360. The welcome page may be configured to allow a user to define his or her mood through a selection interface comprising multiple moods. Accordingly, in step 365, the video game system may request and receive a mood selection and subsequently determine and provide constructive information to the player in step 370. For example, information may be provided to educate the player and may include medical and non-medical information (e.g., information derived from alternative medicine). In one or more arrangements, the information provided may comprise multiple parts: a hint, a suggestion, and an action (e.g., automatically selected by the system) and may be conveyed through a tutor displayed in a game interface. Hints may indicate how the user is feeling and the user's stress level while suggestions offer a proposed course of action to address the issues identified in the hint. The action may correspond to an interaction the user may perform with elements of the welcome page to engage in one or more suggested activities that help to address the issues. For example, if the game system determines that a user is stressed, the game system may provide a message such as “you seem too stressed today. Medical experts suggest taking a bath and drinking herbal tea when you're stressed out. Would you like to know more?” In the above example, the hint includes the message: “you seem too stressed today,” the suggestion includes: “Medical experts suggest to take a bath and drink a herbal tea when you're stressed,” and the action corresponds to the question “Would you like to know more?” In another example, the game system may provide a welcome page including the message “Today you seem too stressed. Take a brief Progressive Muscle Relaxation session or listen to some relaxing music to relax. Turn me around to listen to music or click on me to perform a Progressive Muscle Relaxation session.” In this alternative example, the hint includes “today you seem too stressed,” the suggestion includes “take a brief Progressive Muscle Relaxation session or listen to some relaxing music to relax,” and the action corresponds to “turn me around to listen to music or caress me to perform a Progressive Muscle Relaxation session.”

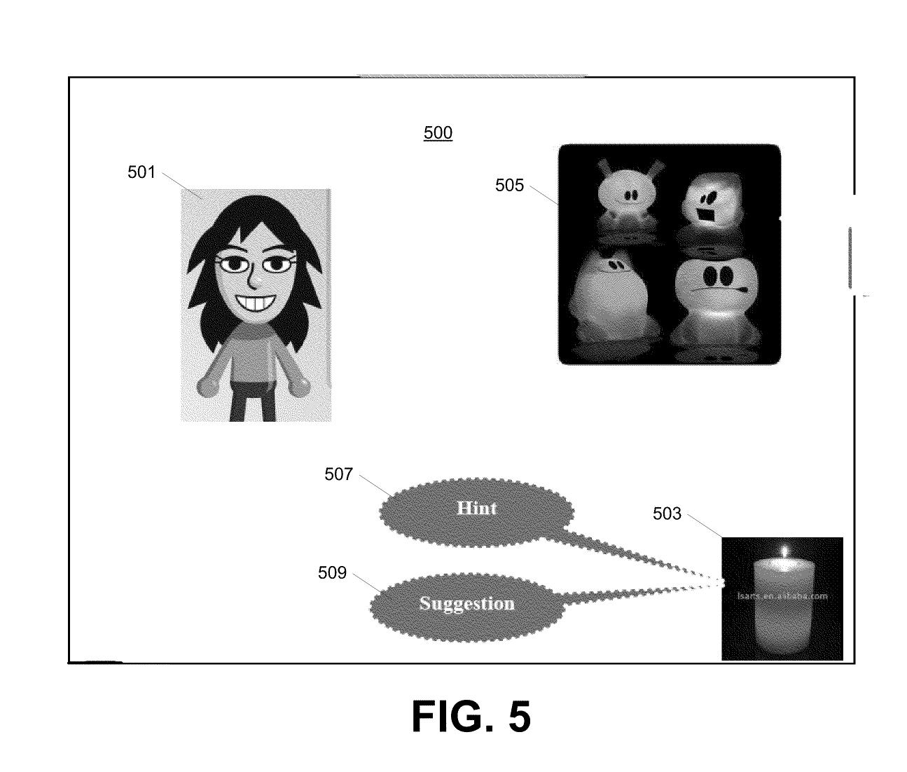

FIG. 5 illustrates an example welcome page 500. Welcome page 500 may include a player avatar 501, a tutor 503 and a mood selection interface 505. Mood selection interface 505 may include multiple moods from which the player may select. The moods may be represented by facial expressions and/or characters that exhibit those moods. Mood selection may be connected to tutor 503. That is, while a player's avatar 501 may remain the same (e.g., same animations and/or facial expressions regardless of mood), the tutor 503 may change mood upon selection (representing your mood status) from interface 505. The mood you choose may also influence hint 507 and suggestion 509 a player may receive from tutor 503. For example, when a player selects his or her daily mood, tutor 503 may change its mood (e.g., by changing facial expression or modifying some other attribute such as an intensity of a flame if the tutor is a candle) and start behaving differently (angry or larger flame if you feel angry and so on). The mood may be reflected by body movements, body posture, facial expressions and/or information provided by tutor 503. Hint 507 and/or suggestion 509 conveyed by tutor 503 based on the selection of a mood may be retrieved from a database of multiple different hints and/or suggestions. Accordingly, the hints 507 or suggestions 509 may be different for each time a player selects a particular mood (e.g., angry).

According to one or more aspects, tutor 503 may provide different messages, e.g., through the use of chat bubbles 507 and 509. For example, hints, suggestions and/or actions may be conveyed to a player through chat bubbles 507 and 509. Alternatively or additionally, the hints, suggestions and/or actions may be conveyed through audio rendered through an audio output device such as a speaker of a television.

Progression from interface to interface may rely on player motions. For example, to progress from a welcome page to an activity menu, the player may be required to move his or her hand (with a controller) in a circular motion. In another example, to move back in a sequence of menus, the player may be required to move his or her hand in a line from right to left. Various types of actions may be defined for navigating a set of interfaces. By having the user perform actions that may require more focus or concentration than mere selection of an option on a screen by pressing a button, the player's stress level may be lowered (e.g., greater focus helping to lower stress levels).

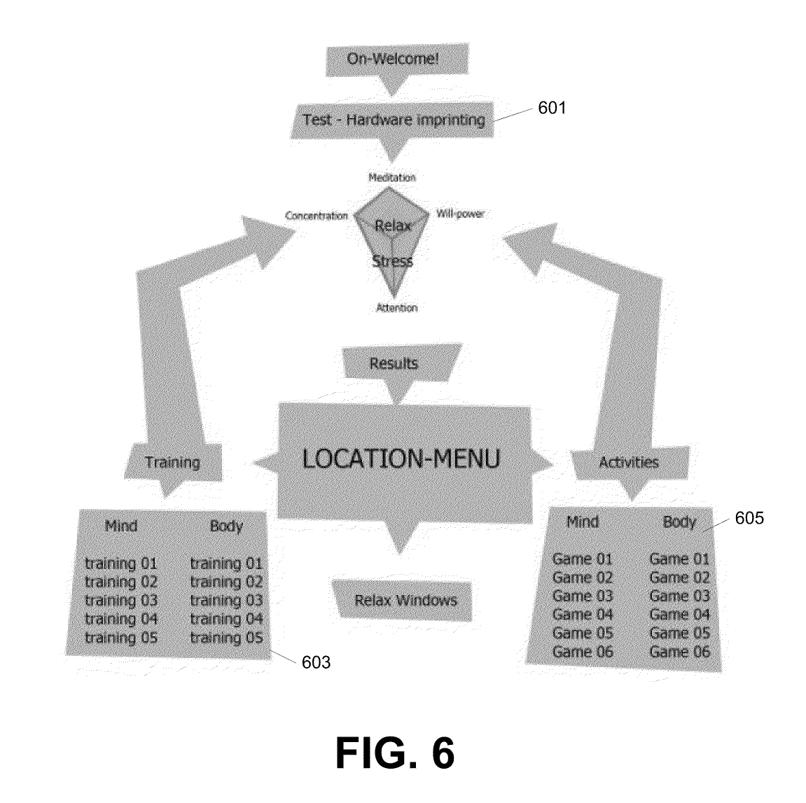

FIG. 6 is a flow diagram illustrating a manner in which a suggested training program may be automatically generated or selected based on the results of a relaxation test. The relaxation test 601 may test a variety of mental and physical attributes including will power, concentration, attention, meditation, heart beat, pulse, blood pressure, oxygen saturation in blood, and define a level of stress and relaxation based thereon. In accordance with those results and/or player-defined attributes including a training goal (e.g., as specified in step 320 of FIG. 3), the game system may select training functions 603 and activities 605 to improve one or more of the above identified mental and physical attributes. Training functions 603 may comprise non-entertainment oriented activities through which a user's relaxation level may be improved. Activities 605 on the other hand may comprise entertainment-oriented applications that are directed to lowering stress levels by entertaining the player while also providing stress reduction awareness or education. The selected training functions 603 and/or activities 605 may collectively be included in an automatically generated training program (which, later, may be customized by the user). In one example, if a player's level of relaxation is below an average threshold, a training program including a daily list of multiple video games focused on relaxation may be selected for the player. If, on the other hand, the player's level of relaxation is above the average threshold, the automatically determined training program may include a single relaxation video game to be played each day. In other examples, video games and training programs may be selected based on a player's physical attributes. For example, if a player does not exhibit adequate fine motor skills, other activities that do not require fine motor skills such as bowling or turning a steering wheel in a racing game may be selected.

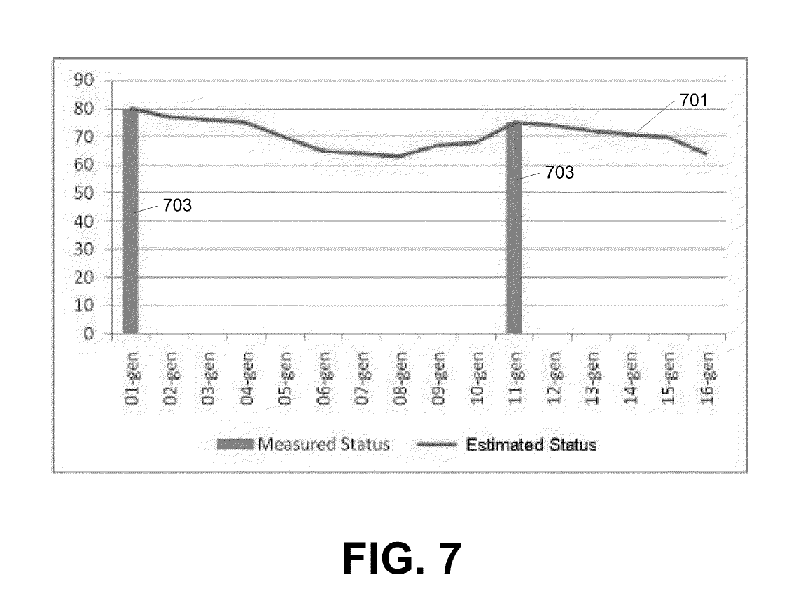

Additionally, the game system may determine a training status of the player based on a selected training goal, the determined training program and the measured physical and mental attributes of the player (e.g., a current relaxation/stress level). In one arrangement, the training status is an estimated or projected progression of a player's relaxation or stress level that would result from the automatically generated (or the customized) and selected training program and the training goal (e.g., where the player should be on a particular day based on the training scheduled for and leading up that day). FIG. 7, for example, illustrates an estimated or projected mental or physical attribute level 701 over a period of time. Actual measured statistics 703 may be displayed overlaying the projected levels 701 to illustrate whether the player is on track, exceeding the specified goals or underachieving.

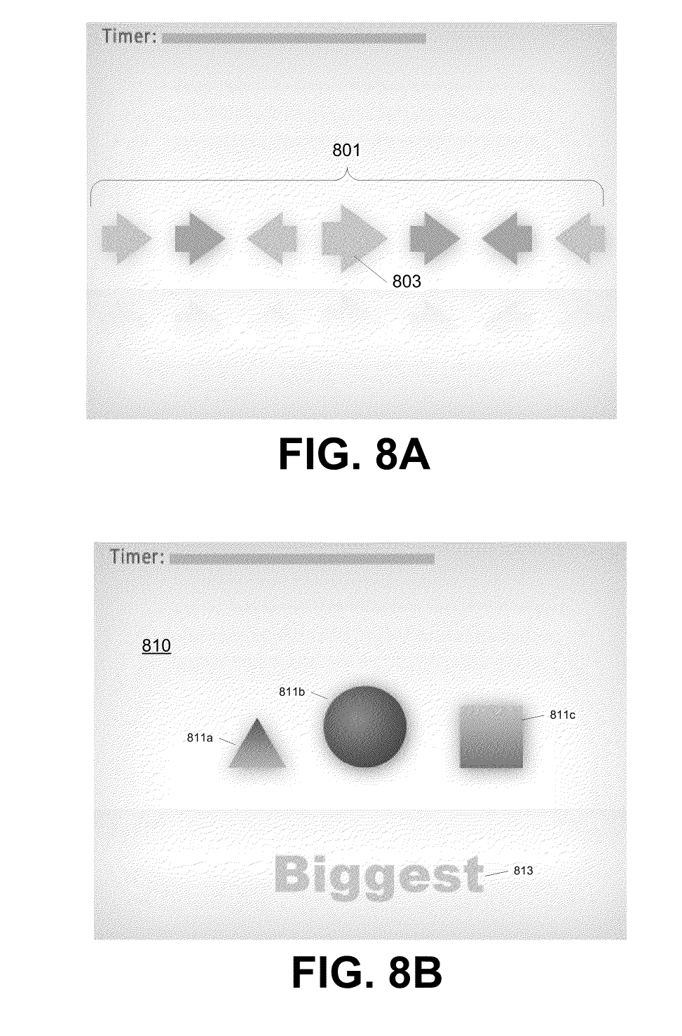

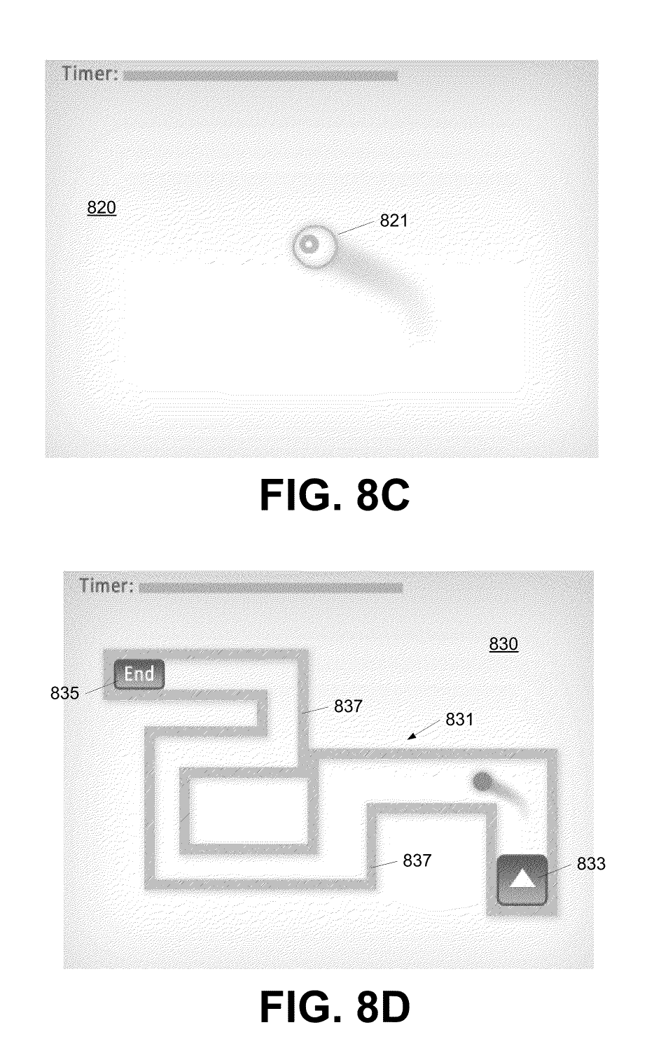

FIGS. 8A-8D illustrate various types of relaxation tests that may be performed upon a player selecting a new profile or if the player wishes to update his or her information. As noted, these tests might only need to be performed if an EEG or any other relaxation/stress measurement and monitor device is not available (e.g., connected to the gaming system). FIG. 8A, for example, illustrates a divert application designed to evaluate a player's concentration/attention level. The application includes a series of arrows 801 that point in various directions. The player is instructed to select a direction (e.g., via a directional button, via a direction of movement, a motion) opposite of the direction of the arrow. An arrow in play 803 (e.g., an arrow for which a player must select an opposite direction) may be identified by a focus indicator. In one example, the focus indicator may correspond to altering the appearance of the arrow in play 803, e.g., enlarging the arrow making it larger than the others. In another example, the focus indicator may include a change in color of the arrow and/or displaying an outline (e.g., a box) around the arrow in play. Based on the number of mistakes and the speed with which responses are entered by the player, the video game system may determine a concentration modification value. This modification value may be used to adjust a default or base concentration level that is determined at the time the player completes the questionnaire.

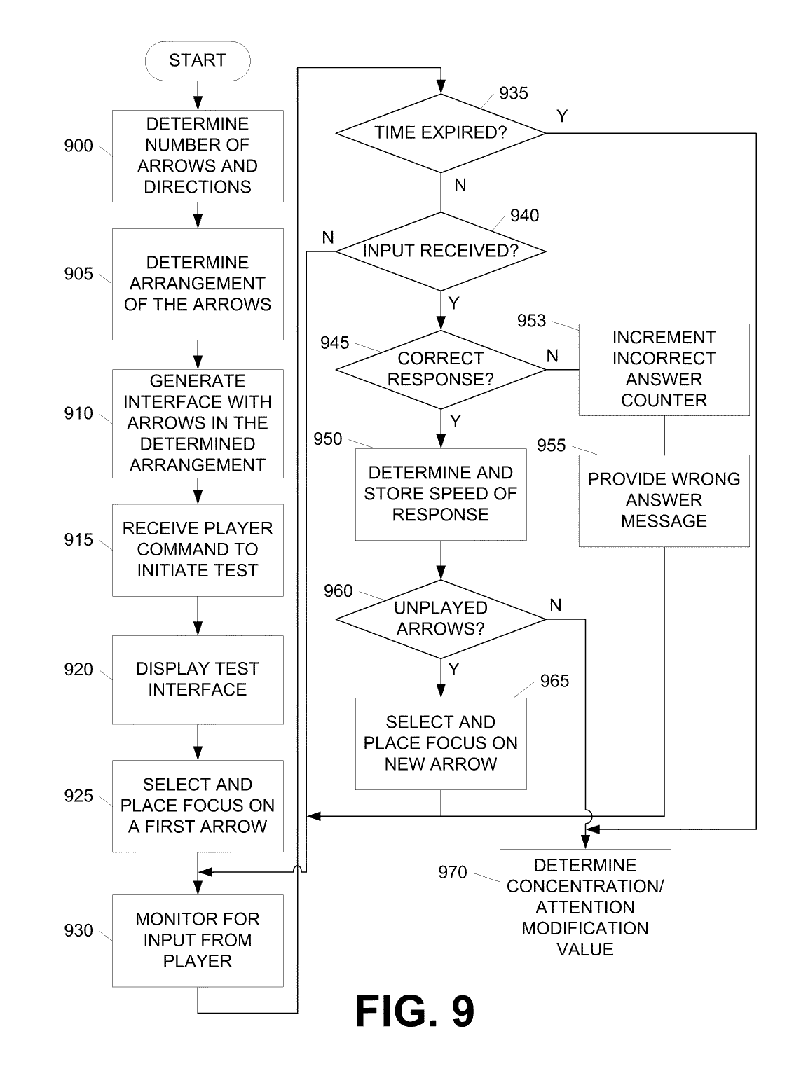

FIG. 9 illustrates a process flow by which the concentration test of FIG. 8A may be generated and evaluated. In step 900, a number of arrows and their directions may be determined by a video game system. The number of arrows may be determined based on a predefined test parameter, while the direction may, in one or more examples, be randomly selected. Alternatively or additionally, the direction of the arrows may be decided by a default a configuration (e.g., half in a first direction and half in a second direction). In step 905, the video game system may subsequently determine an arrangement of the arrows in the interface. The arrangement may be determined based on a default or a selection algorithm that insures that no more than two adjacent arrows face the same direction. In step 910, the video game system may generate a test interface that includes the arrows in their determined directions and in the determined arrangement.

Once the video game system has generated the concentration test interface, the video game system may receive a player command to begin the test in step 915. The command may correspond to the user pressing a start button or other button configured to initiate the test. In response to the player command, the video game system may display the generated test interface and begin a timer in step 920. In step 925, the video game system may select and place focus on a first arrow. In one or more examples, the first arrow may be selected randomly. Alternatively, the first arrow may be selected according to a predefined sequence (e.g., left to right, right to left, non-consecutive sequence). In step 930, the video game system may monitor for input from the player. In step 935, the video game system may determine whether a total test time has expired. If not, the video game system may determine whether player input has been received in step 940. If not, the video game system may determine whether the player input corresponds to a correct response (e.g., corresponds to a direction opposite the direction of the arrow) in step 945. If the player input corresponds to the correct response, the video game system may determine and store a speed of the correct response by determining an amount of time lapsed since selection of/placing focus on the current arrow in step 950. If, however, the player input does not correspond to the correct response, an incorrect answer counter may be incremented by 1 and a message indicating a wrong answer may be provided to the player in steps 953 and 955, respectively. For example, the video game system may generate and display the word “Incorrect” in the test interface. The video game system may further revert to step 930.

If the answer is correct, the video game system may further determine whether another arrow has not yet been put into play in step 960. If such an arrow remains, the video game system may select and place focus on a new arrow in step 965 and return to step 930. If, on the other hand, no other such arrows exist, the video game system may determine a concentration modification value based on the determined speed and a number of incorrect responses in step 970. In one example, a concentration/attention modification value may be increased (indicating greater concentration) by 5 for every response given in under 0.5 seconds, while the modification value may be decreased by 5 for every response given in over 1 second. Additionally or alternatively, the modification value may be decreased by 1 for every incorrect response. Incorrect responses might only be counted once for every arrow such that even if a player responds incorrectly 3 times for a particular arrow, the modification value might only be modified once (decreased by 1) for those 3 incorrect responses. Various other determination algorithms may also be used. In one or more examples, the concentration modification value may be applied to an initial concentration level determined through the initial relaxation/stress tests or may be applied to a default concentration value.

If, in step 940, the video game system determines that the total test time has expired, the video game system may proceed directly to step 970. For each arrow that was not put into play by the expiration of the time limit, the video game system may count those as incorrect responses.

FIG. 8B illustrates a focus test that may also be configured to test the concentration/attention level of a player. For example, in focus test 810, the player may be instructed to select the correct object 811a, 811b or 811c that corresponds to a description of caption 813. For example, objects 811 may comprise differently sized blue triangle 811a, red circle 811b and orange square 811c and caption 813 may include the word “BIGGEST.” Accordingly, the player may be required to identify object 811b as corresponding to what is described by caption 813, i.e., “BIGGEST.” A concentration level of the player may be adjusted and determined based on the speed and accuracy of the player's responses. In one example, speed, accuracy and a concentration modification value may be determined for the focus/concentration test of FIG. 8B in similar fashion to the process of FIG. 9.

FIGS. 8C and 8D illustrate examples of relaxation level tests for measuring a level of stress associated with the player. In FIG. 8C, for example, a player may be asked to track a moving object 821 in interface 820. The player may follow object 821 by moving a cursor using a controller such as controller 203 of FIG. 2. A relaxation value or modification value may then be determined based on an amount by which the player's handle (or a controller held therein) trembles. For example, the tremble amount may be calculated using the difference in time and distance between the location of the spot and the location of the cursor controlled by the player. In particular, the difference in distance may be multiplied by an amount of time (e.g., a number of seconds) that the cursor's location does not match the location of object 821. In one or more arrangements, a tolerance may be used so that a cursor within a predefined distance of object 821's distance may still be considered a match. As with a concentration level, the relaxation value or modification value may be applied to a predefined or default relaxation value.

FIG. 8D illustrates another example relaxation level test in which a player's goal is to draw a line through a maze or labyrinth 831. The player may be required to begin from starting point 833 and direct an object, cursor, line or other item to end point 835 without touching walls 837. In some instances, if the player controlled cursor or object touches one of walls 837, the cursor may be returned to starting point 833. Additionally or alternatively, if the player goes backwards (e.g., crosses or traverses a path previously traversed), the player's cursor may also be returned to starting point 833. Each of these instances where a player may be returned to starting point 833 may be considered a mistake or error. A video game system may then determine a relaxation value (or modification value) based on the amount of time required for a player to reach end point 835 and a number of mistakes made. The amount of time required for a player to reach end point 835 may be calculated based on the beginning of a first try to a time at which the reaches end point 835. Accordingly, if a player is returned to start point 833 one or more times, the time used may be cumulative among all attempts.

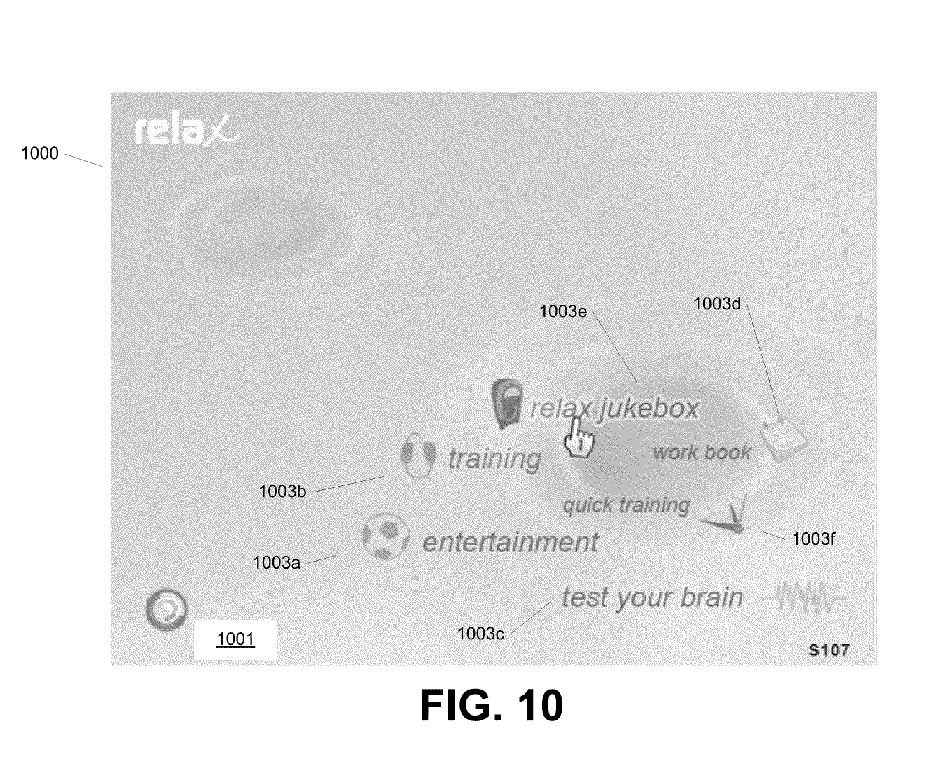

FIG. 10 illustrates an example menu interface 1000 that may be reached after player selecting a new profile has completed the relaxation/training tests and inputted various player data (e.g., block 320 of FIG. 3), after a guest profile has inputted player data (block 320 of FIG. 3) or after an already known profile has passed through a welcome page such as interface 500 of FIG. 5. Menu 1000 may have include a background image 1001 and multiple selectable options 1003 for accessing different types of games, training, tests, entertainment, information and player statistics. Options 1003 may be represented by objects within background image 1001. In one or more arrangements, options 1003 may be represented by animated objects or displays.

Selection, hovering over or otherwise interacting with each of options 1003 may cause an activation of the sub-menus. A sub-menu may correspond to animated objects that may be displayed as a pop-up interface overlaying background 1001 or may comprise a new interface that replaces interface 1000. The following describes sub-menus that may be displayed upon interacting with one of options 1003 in one or more examples:

Training: In a training sub-menu, a player may continue a previous training session, select preset training programs, customize a training program, and/or access mini-training programs by selecting training option 1003b.

Entertainment: Selection of entertainment option 1003a may cause a menu to be displayed that includes one or more stress relief games.

Test Your Brain: Test Your Brain option 1003c consists of a quick test of the user's brain activity, with gauges and graphical elements used to represent and convey a real-time display of the user's brainwaves, brain frequencies and the relaxation and attention parameters or any other biometrical parameters which may be used to show the user's relaxation and/or stress levels. The test may be completed reporting a final score which corresponds to a measurement of the current user's relaxation and/or stress level.

Workbook: Workbook option 1003d allows a player to view his or her statistics including an amount of progress, comparisons with other players, a measured status, a training status, a workbook with information of user's daily/monthly scheduled activities and workouts

Relax Jukebox: Relax Jukebox option 1003e may provide a player with a “virtual” jukebox consisting of a compilation of relaxing screensavers along with relaxing soundtracks that may be rendered to help reduce stress and help the player to relax.

Quick Training: Quick Training option 1003f allows the player to select preset mini-training programs and/or to enter a disciplines selection interface, as described in further detail below.

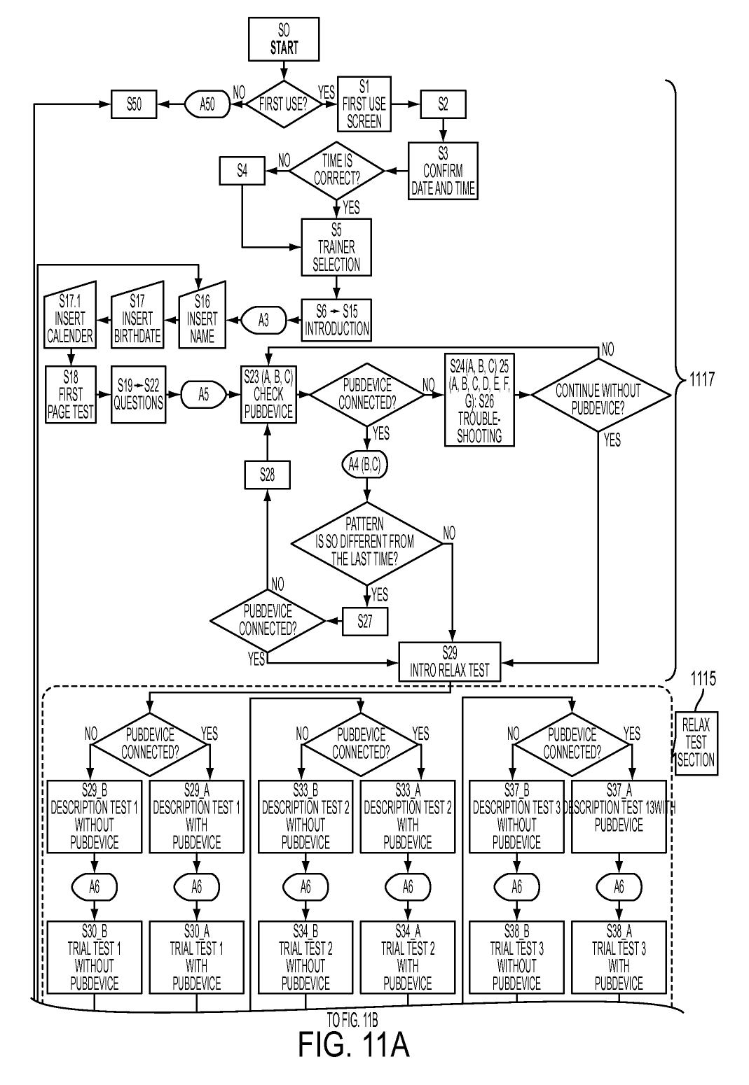

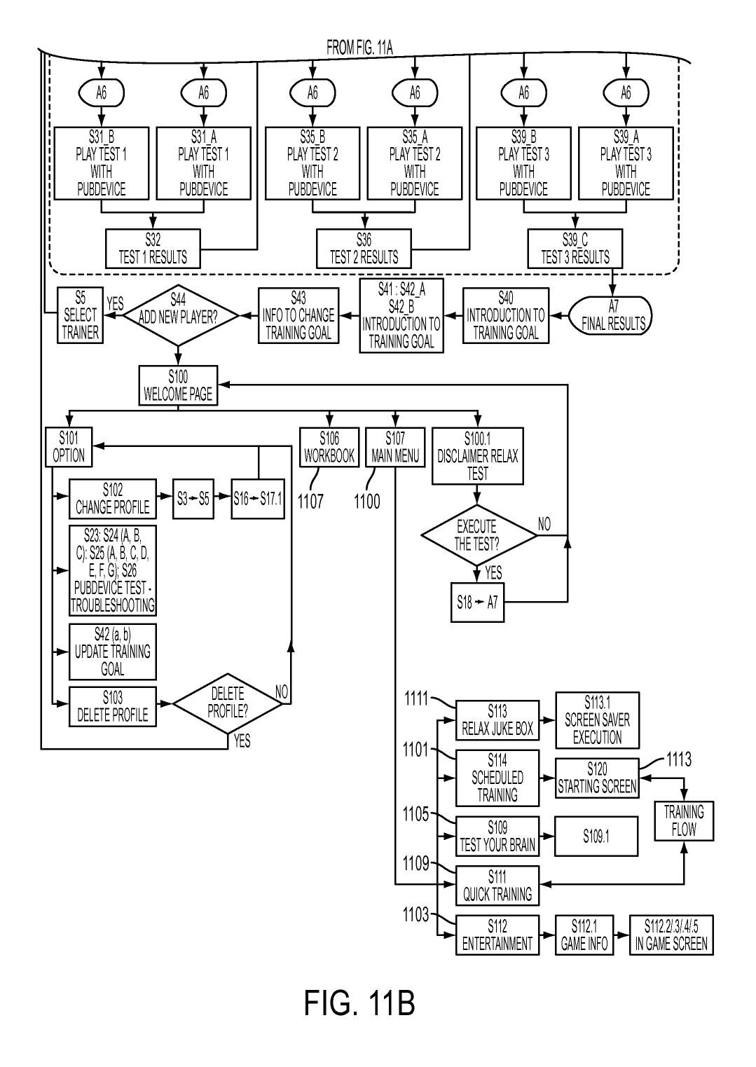

FIG. 11 illustrate example navigation flows defining maps through which a user may navigate to various interfaces and options such as interface 1000 and options 1003 thereof of FIG. 10. From main menu 1100, a user may proceed to training option 1101, entertainment option 1103, Test Your Brain option 1105, Workbook option 1107, Quick Training option 1109 and Relax Jukebox option 1111. A user may also proceed directly between each of options 1101-1111. Additionally, the navigation flow may include an initialization section 1117 that may include processes or screens for receiving user information such as a name, birthdate, trainer selection, introduction information, calendar definition and the like. The initialization section 1117 may further be configured to determine connected or available devices in order to determine what activities, information and/or entertainment to provide the user. A relaxation test section 1115 may also be provided to determine a user's initial level of relaxation and physical fitness before determining the activities, information and entertainment to provide to the user. The types of tests used may be determined based on the types of devices connected to the gaming system.

If training option 1101 is selected, a recap interface may be generated in block 1113 through a training starting screen and displayed to the player. A recap interface may display a variety of information and options.

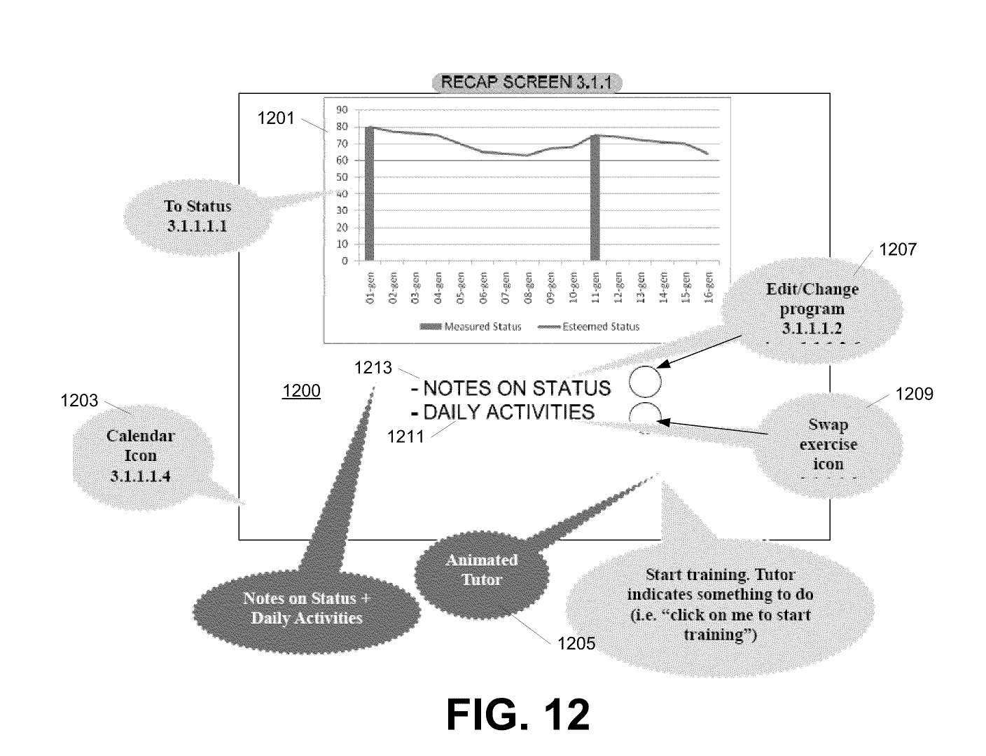

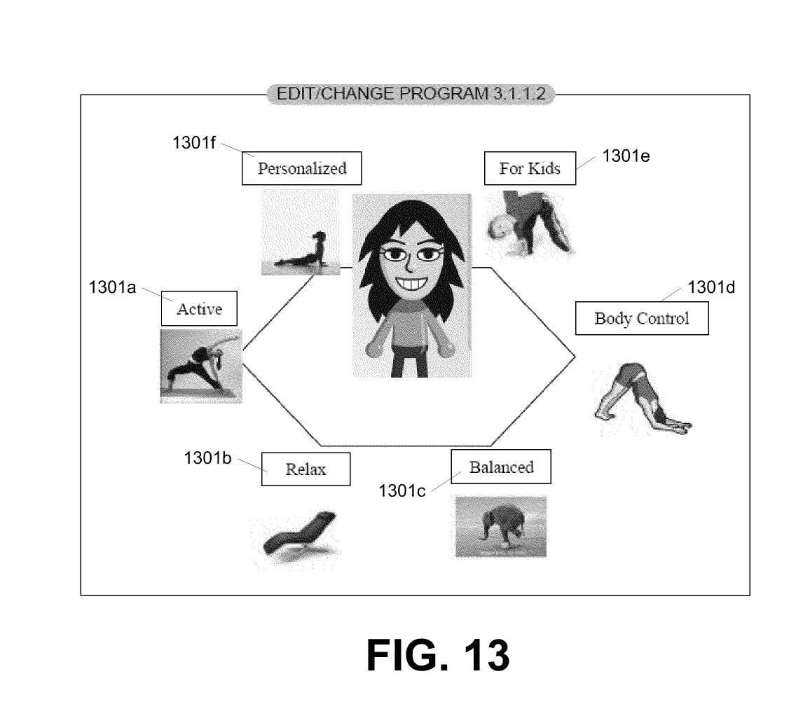

FIG. 12 illustrates an example recap interface 1200 in which a training summary 1201 may be displayed along with a calendar 1203, tutor 1205, edit/change program option 1207, swap exercise function 1209, daily activities 1211 and status notes 1213. Selecting training summary 1201 may allow a user to access additional training analysis information including, for example, an amount by which the player is overachieving or underachieving based on projected statistics and/or statistics regarding various physical and mental attributes of the player. Selecting calendar 1203, on the other hand, may cause an activity calendar to be displayed, where the activity calendar indicates the days on which activities are scheduled. FIG. 13 illustrates an example activity calendar in which a player may view a detailed list of activities, notes and/or a workbook for a particular by selecting the day.

Referring again to FIG. 12, status notes 1213 may include various types of information including a short message indicating whether the player is on track, underachieving or overachieving. Furthermore, daily activities 1211 may be displayed to provide quick reference to the activities that are to be performed on a current day as defined by a selected and/or automatically generated training program. Edit/change program option 1207 may be displayed alongside daily activities 1211 to allow a user to edit or change the training program currently in place. For example, selecting option 1207 may cause an interface listing other available training programs to be displayed. Alternatively or additionally, the interface may allow the player to customize the training program without selecting an entirely different program. In one example, selecting edit/change training program option 1207 may display a list of pre-set training programs including an active program, a relax program, a balanced program, a body control program and a kids training program. For example, in the case of body training, the list may include:

Active: This program may be primarily (or entirely) focused on an physical level and active side. It may include a set of activities which allows a player to reach a physical goal such as increasing physical fitness while also reducing stress. In one example, an active training program may include 50% Yoga exercises, 25% Tai-Chi, 25% Pilates.

Relax: This program may be primarily (or entirely) focused on relaxation. It may include a set of activities which allow you to reach a goal such as increasing mental stability, awareness and/or reducing stress. In one example, a relaxation training program may include 30% Massage, 30% Qi-Gong, 30% Progressive Muscle Relaxation, 10% Screensaver (visualization & listening) sessions (e.g., 5 mins each).

Balanced: a mix of the active and relax training programs. This training program may be designed to improve both physical fitness and mental fitness equally while reducing your stress level. In one example, a balanced training program may comprise 15% Yoga, 15% Tai-Chi, 15% Qi-Gong, 15% Massage, 15% Pilates, 15% Progressive Muscle Relaxation, 10% Screensaver (visualization & listening) sessions (e.g., 5 minutes each of multiple screen savers).

Body Control: This training program may be directed to reducing stress while helping a player become more aware of his or her body (e.g., Yoga practices, Progressive Muscle Relaxation, etc.). In one example, a body control training program may comprise 20% Progressive Muscle Relaxation, 20% Pilates, 20% Massages, 20% Yoga and 20 Tai-Chi.

For Kids: This program may be specially designed to include simple and fun activities for children. In one example, a schedule of activities may comprise 40% Pilates, 40% Progressive Muscle Relaxation and 10% Tai-Chi.

Alternatively, if a player is engaging in mind training, a list of pre-defined training programs may include mental stability program, mental strength program, mental growth program, kids program and a personalized program (e.g., customized).

FIG. 13 illustrates an interface 1300 through which the various preset programs may be selected. Upon selection one of programs 1301, a player may be allowed to customize the program if they so choose. In one or more arrangements, the Edit/Change Program interface 1300 may include a 3D rotating selection: using a motion sensitive controller, a player may rotate the 3D polygon (a hexagon or a circle). The programs 1301 may be placed in the corners and the animated avatar 1303 may remain in the center. Each of programs 1301 may have an animated or graphic icon that briefly points out its function. A tutor (not shown) may also be active, illustrating the choices and helping the player navigate. In one example, a tutor may describe the benefits of an activity when a player has rotated to that program.

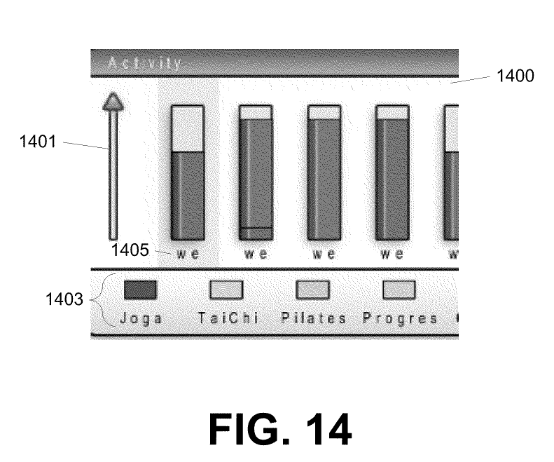

As noted herein, a player may customize one or more of the above programs or create his or her own program from scratch. For example, FIG. 14 illustrates a training program customization interface 1400 where a user may modify slider 1401 to adjust the amount of each of activities 1403 scheduled for a particular day 1405 or other time period. A color or shade of slider 1401 may correspond to different activities.

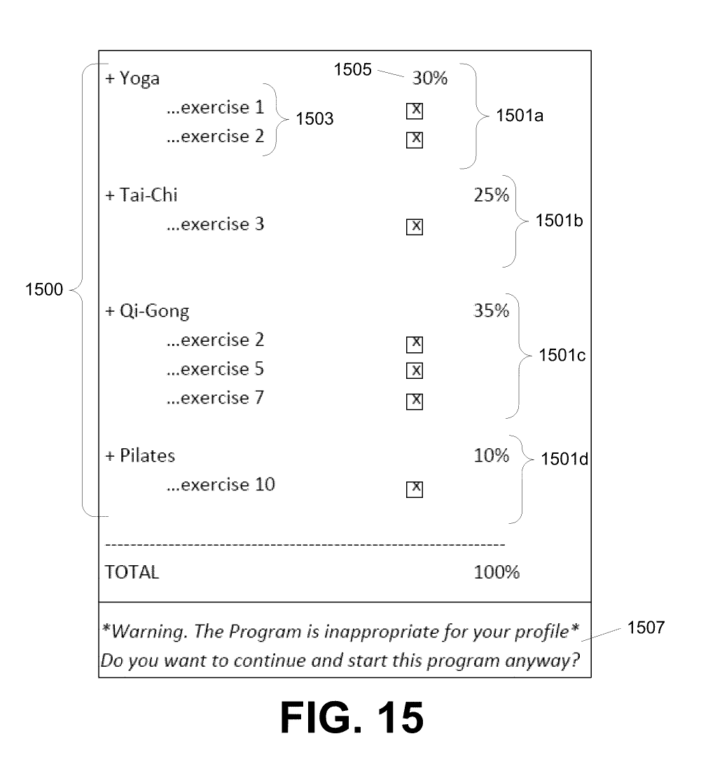

FIG. 15 illustrates an example interface through which a user may modify or customize a training program. Training program 1500 may be broken down into disciplines (e.g., categories of exercises) 1501 that are displayed as expandable/collapsible menus. Upon expanding one of disciplines 1501, a list of exercises 1503 corresponding to that discipline 1501a may be displayed. Players may then select or deselect the exercises 1503 that they wish to include or eliminate, respectively, from training program 1500. Additionally or alternatively, the percentage makeup 1505 of program 1500 may be indicated and may be modified according to a distribution preferred by the player. If a percentage is changed without changing the other percentages and the percentages 1505 do not add up to 100% after the change, the other percentages may be automatically re-calculated based on the modification so that the total is 100%. If the customized program 1500 is not appropriate for a player's profile (e.g., too difficult or strenuous or too easy to achieve desired results), a message 1507 may be displayed indicating that the profile (e.g., profile 1500) is in appropriate and asking for confirmation to select or start the program.

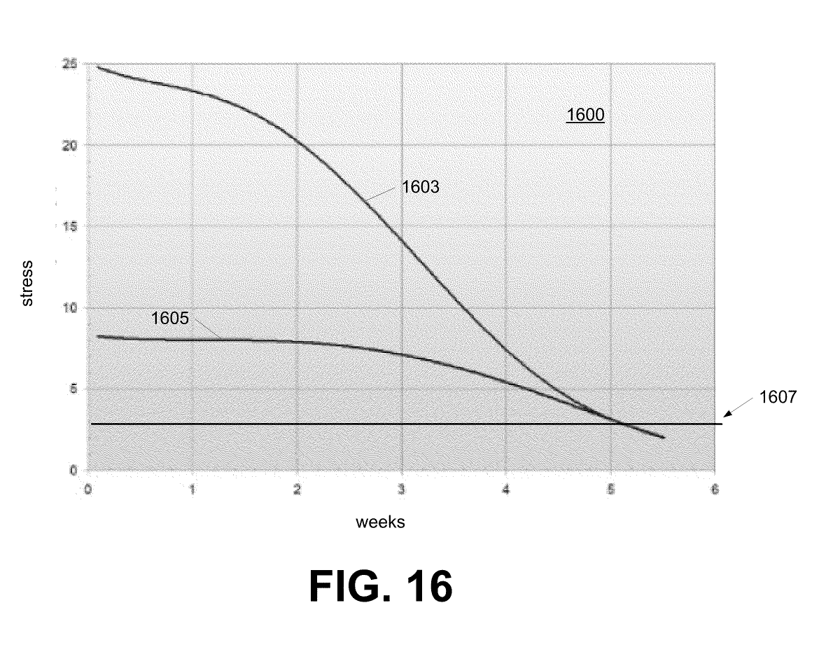

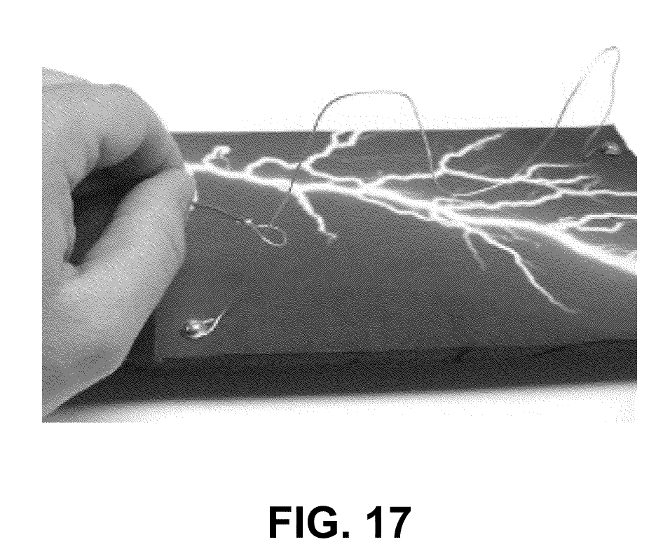

If a player chooses to customize a program, a video game system may display a graph comparing the amount of each exercise or discipline that will be performed for the customized program versus the predefined or automatically generated training program. The graph may also compare projected results (e.g., heart rate, stress level, strength) for each of the programs. For example, FIG. 16 illustrates a graph 1600 in which a user's projected stress level is displayed for each of a predefined training program 1603 and a customized training program 1605. Such information may provide a player with further information to help modify his or her training program to reach a desired result/schedule. The graph 1600 may also display goal indicator 1607. For example, if a player wishes to reduce his or her stress level 20 points, the graph may draw a line 1607 indicating this goal. Additionally or alternatively, the graph may specify intermediate goals (e.g., split by month, week, day, etc.) based on the general goal and an amount of time allotted for reaching the goal. In some instances, the intermediate goals may be determined based on a linear interpolation. In other instances, the intermediate goals may be determined based on non-linear interpolation (e.g., slower start, faster finish).

Referring again to FIG. 12, another method of changing activities is to choose swap exercise function 1209 displayed alongside status notes 1213. This may allow a player to exchange activities that are both specified in a currently active training schedule. Using swap exercise function 1209 may restrict the player for altering exercise amounts and exercise types. That is, the player might only be able to switch between exercises already defined within a training schedule. Thus, all exercises scheduled must still be performed, albeit in a slightly different order. This may be a helpful option to use if, for example, a player becomes injured and would like to rearrange the schedule so that body exercises are performed later in the schedule.

Referring back to FIG. 11, if a player selects an entertainment option such as option 1103, the player may be provided a menu of games or other entertainment activities. In one or more arrangements, the menu of games may include game information describing each of the available games. Different entertainment activities may require different controllers or input mechanisms such as an EEG or any other relaxation/stress measurement and monitor device or a hand held controller. For body training, for example, a user may be select one of the following games:

Wire Loop Game: This game may be single player or multiplayer and may comprise multiple levels of different circuits. In the game, a player must guide a virtual metal loop along a length of virtual wire without touching the loop to the wire. The loop and wire are connected to a power source in such a way that, if they touch, they may form a simulated closed electric circuit. The in-game circuit may include a light- or sound-emitting device/function of some form, which indicates that the game has been lost or a mistake has been made. The game may require the player to maintain focus, keep relaxed, and steady his or her hands while moving the loop along the wire. Different wire configurations may be used to adjust difficulty. Controls for the game may comprise a handheld controller, an EEG controller (e.g., worn on the head) or any other device which allows to use biometrical parameters related to user's relaxation and concentration/focus levels to control the game and/or a board controller on which a user may stand or sit. For example, with a handheld controller (e.g., a WII mote), a player may control a pointer to select and move the ring on the wire. The controller may rumble (e.g. provide haptic feedback) and/or produce sound effects when the wire is touched. Optionally, with an EEG controller or other devices that measure and monitor biometrical parameters, relax or attention (e.g., Focus/Concentration) parameters (or both parameters combined) may control speed and hand/cursor/loop steadiness. A user may select or define which parameters are used (e.g., relax or attention or both). In another arrangements, a player may use a balance board such that a handheld controller is used to select and keep the ring and the balance board controller is used to keep the ring steady and/or to move the ring (e.g., shift in weight may cause the ring to move in one direction or another). FIG. 17 illustrates an example wire loop game interface.

Free Climbing: An activity that may be performed optionally using an EEG device, or other devices that can allow transforming biometrical parameters into game commands, and that may be played in single and multiplayer modes. Difficulty of the game may be controlled by the objects that a player is virtually climbing. For example, an easier mode may correspond to a wall while a harder mode may correspond to the Petronas Towers or the Burj Dubai. In a free-climbing game, a player may be required to maximize his or her attention/relaxation parameters to progress or climb an object. The game may allow a player to challenge the video game system (e.g., artificial intelligence thereof) or friends (e.g., locally at the same video game system or remotely through a network). The better climber or winner may be determined by the player that has the higher score. Additionally, a specified score may be required to advance to harder or other levels. The game may further include an automatic system that guides the player in taking the next step on the wall. For example, with a handheld controller, the button or motion required to move on to a next step on the climbing object may be indicated by the guide. Additionally or alternatively, climbing may be based on timing that requires a user to grip (e.g., press a button or make a motion) at the right time, otherwise the player will slip and fall. Additionally, the handheld controller may be used to determine grip and balance (automatic climbing). For example, trembling may be interpreted as having a weaker grip on a climbing surface. If a player uses an EEG controller or other devices that can allow transforming biometrical parameters into game commands, an attention parameter may be used to climb (automatic grip) while a relax parameter may be used to determine and control the player's balance. FIG. 18 illustrates an example climbing game interface where a player's avatar 1801 may be depicted and instructions for climbing 1803 may be displayed below. The instructions may change more quickly to make the game more challenging or slower to make it easier. If a player does not follow the instructions 1803 before instructions 1803 change, the player may be adversely affected (e.g., a hand might slip off).

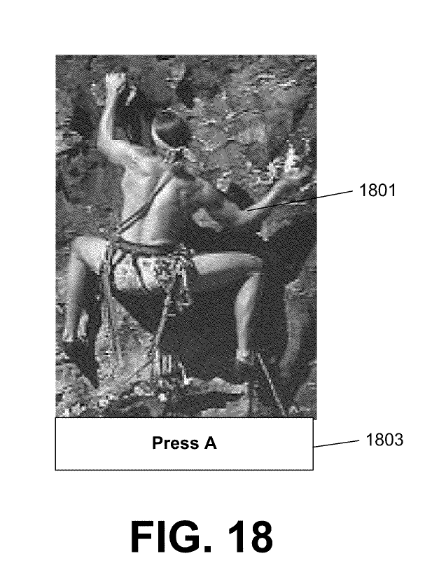

Aeroplane: Aeroplane is an airplane control game that may be played in single player or multi player mode. The game may comprise multiple levels (e.g., 10) and may include bonuses, rewards and penalties. For example, a player may be put in control of a small airplane. The player must pilot the airplane while avoiding obstacles, shooting enemies and obtaining power items or bonuses (bonuses can be spent to increase speed, increase fighting power, etc.). Controlling the airplane may include using one or more handheld controllers (e.g., a WII-MOTE and a NUNCHUK). For example, one controller may control direction of flight while the other may be used to control speed or weapons. Optionally, an EEG controller, or other devices that can allow transforming biometrical parameters into game commands, may be used where a detected relax or attention parameter may be used to speed-up, take-off/land, and/or increase/decreased altitude. Furthermore, a balance board controller may be used to control movement of the plane (e.g., yaw, pitch), acceleration/deceleration and the like. For example, if a user shifts weight forward, speed may be increased. FIG. 19 illustrates an example airplane game interface. In the example interface, a concentration level may be used to maintain an airplane's altitude while a button controller may be used to guide the airplane through various targets (e.g., hoops or bonus items).

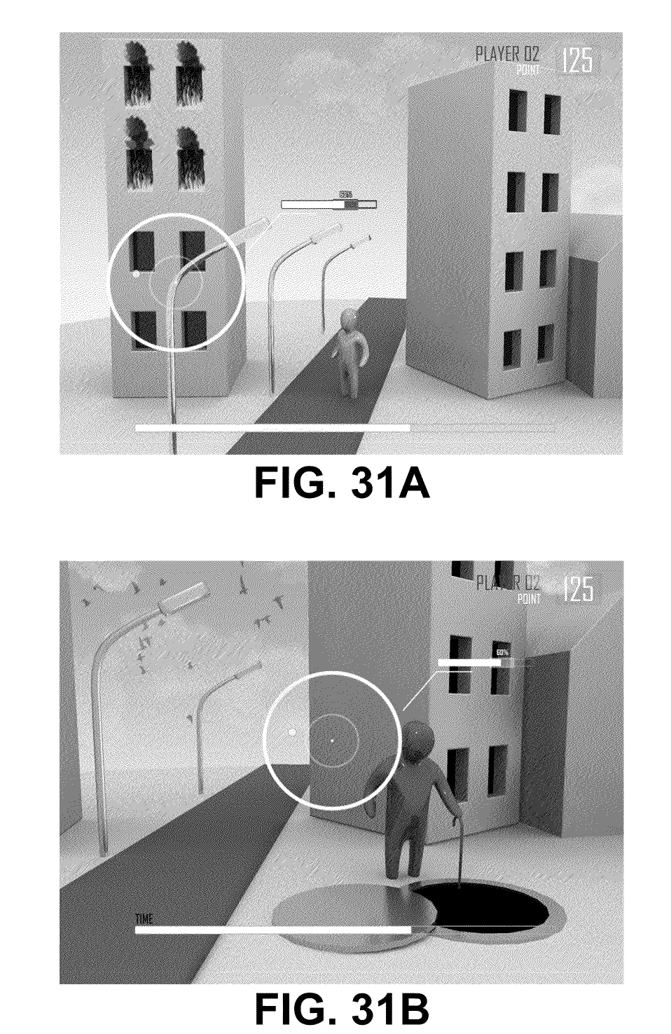

Super Hero: A super hero game may include a single player mode with multiple levels or settings. FIGS. 31A and 31B illustrate example superhero game interfaces. Each level or setting (e.g., amusement park, Tibetan mountains, a house, etc.) may be directed to a different mission. The character (e.g., the super hero) may be created based on the player's avatar and/or player attributes such as weight, height, fitness level, gender, etc. Alternatively, a player may select a character that is not created based on the player's avatar or attributes. For example, the player may customize a character for play in the game or the system may generate it automatically. In one or more arrangements, the super hero may travel around to different levels or settings and complete various super-human missions with the super-power of his mind. The super-powers may be controlled using an EEG controller or other devices that can allow transforming biometrical parameters into game commands. According to one or more aspects, the super hero game might require the use of an EEG controller or other devices that can allow transforming biometrical parameters into game commands. In one example, a relax parameter may be used to control a first power (e.g., flight or time) while another parameter such as attention may be used to activate and/or control a second power (e.g., mind beam). A strength of a power may also vary depending on a measured level of a parameter so that the higher a user's attention, the stronger a mind beam or other offensive power. Movement may be affected by using a handheld controller, a balance board, one or more parameters of the EEG controller or of other devices that can allow transforming biometrical parameters into game commands and/or combinations thereof.

Players may progress in the game upon completing one or more main missions of each level or setting. Furthermore, levels may be locked until a player has completed an immediately preceding level. Upon completing all levels, all levels may be unlocked for free play at any time. In this last case, a scoring system may motivate the player to continue playing and to challenge friends to compete for a higher score. For example, a certain number of points may be awarded per 100 barrels lifted by the super hero, while another number of points may be awarded for every 30 chairs broken, or more points could be earned for completing a mission/level in a lower amount of time.

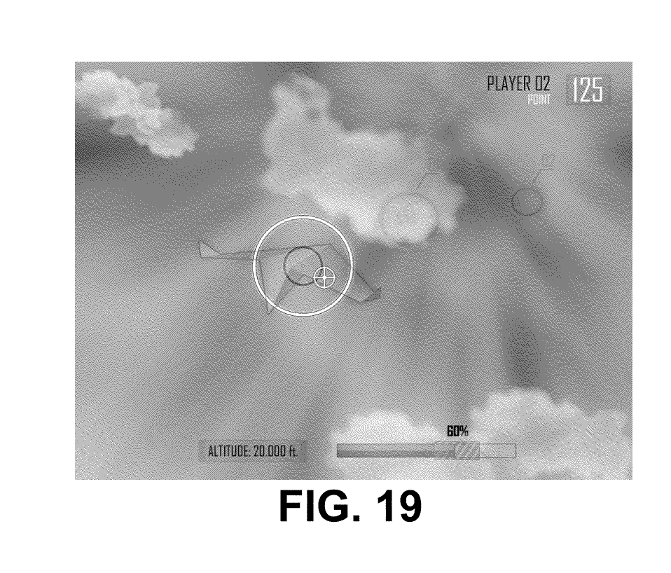

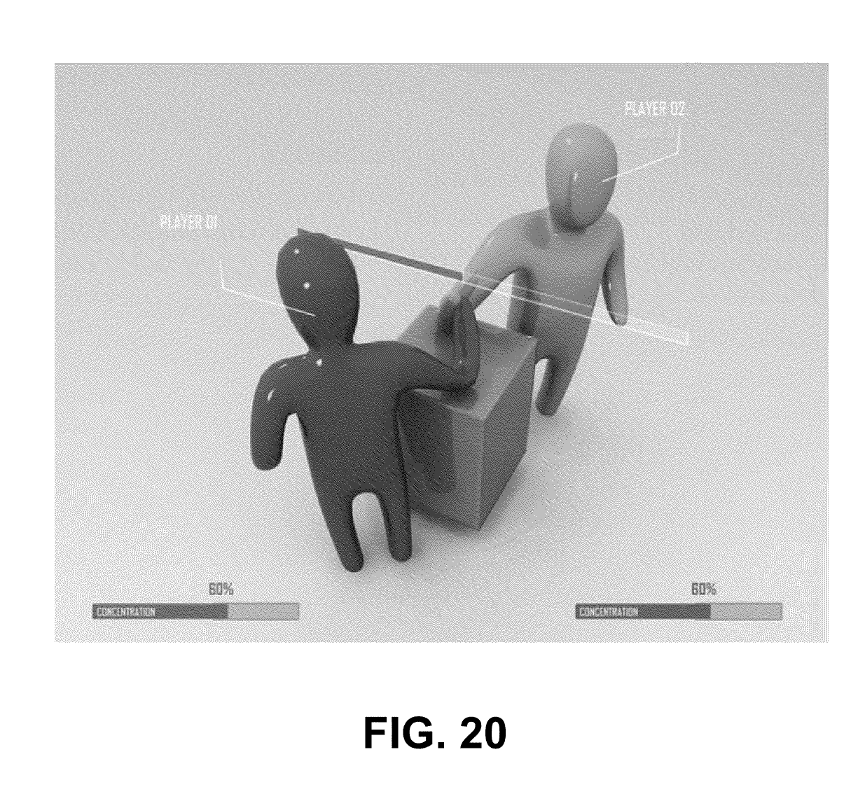

Mind Wrestling: Mind wrestling is a game in which a user may compete with another user or the computer in arm wrestling. However, the strength of a user's arm may depend on one or more parameters detected using an EEG controller or other devices that can allow transforming biometrical parameters into game commands. For example, a player's in-game strength may increase as the player's attention parameter increases. Alternatively, the player strength may also increase as the player's relax parameter increases. In one or more arrangements, the relax parameter or the attention parameter may affect an amount of leverage, which may ultimately affect a momentum and/or force the player's in-game arm or avatar is able to exert. An EEG controller or other devices that can allow transforming biometrical parameters into game commands may be required to play a mind wrestling game. FIG. 20 illustrates an example mind wrestling game interface.

Brain Olympics: Brain Olympics may involve a series of competitive activities such as long jump, archery, sprint, javelin, hurdles, shot-put and the like. In one or more arrangements where a player uses an EEG controller or other devices that can allow transforming biometrical parameters into game commands, the controls for archery may include pulling a bow string with an attention parameter and aiming using a relax parameter. In a sprint competition, an attention parameter or a relax parameter (or both) may be determinative of the player's speed. In long jump, on the other hand, a player's attention may be measured to speed up for a run and a relax parameter may be used to extend a length of the jump. For example, a distance of the player's jump may depend on both the speed of the run as well as a force with which the player jumps. The jumping force may be determined based on the relax parameter. Controls for a javelin game may be similar to long jump in that the player's attention may determine the speed of the player and a relax parameter may help to extend the distance of the throw (e.g., by defining or increasing a throwing force). In hurdles, a player's attention may be used to run till take off, while a relax measure may be used to determine a length and height of a jump. The user may then return to running using attention. The strength, height or force of jumps, throws, shots and the like may further be affected using a handheld controller or a balance board. For example, the amount of time the user's weight is not on the balance board may correspond to an amount of air time during a hurdle jump. In one or more arrangements, an EEG controller or other devices that can allow transforming biometrical parameters into game commands may be required to play the game.

Games or training activities used to train and hone the mind, on the other hand, may include:

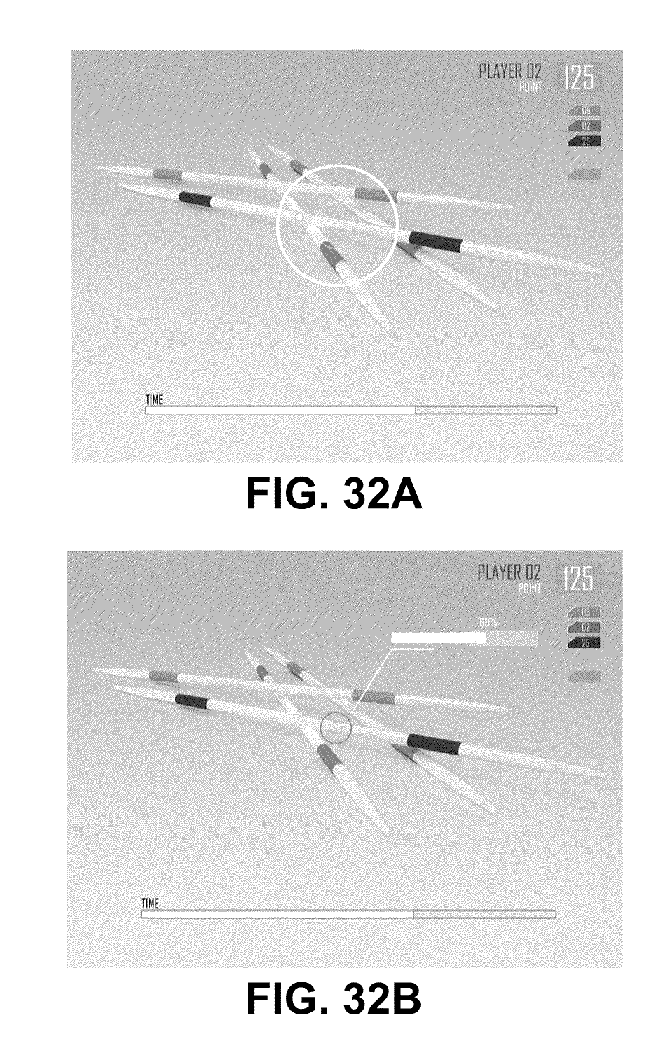

Mikado: Mikado is a game involving the removal of sticks from a pile of overlaying sticks without disturbing any of the other sticks in the pile. FIGS. 32A and 32B illustrate example Mikado game interfaces. The game may have different levels and degrees of difficulty and may be played either alone or in multiplayer mode. Control for the game may include using a handheld controller to select and pick up a stick and move it. Haptic feedback or other types of feedback may be provided when another stick is touched or otherwise disturbed. An EEG controller or other devices that can allow transforming biometrical parameters into game commands, on the other hand, may be used to interact with elements of the game by measuring and transmitting either a relax parameter or an attention parameter or both. For example, the lower the player's relax parameter or attention parameter, the more likely the player will disturb another stick in the pile during the pick up phase. The EEG controller or other devices that can allow transforming biometrical parameters into game commands may be used in combination with a handheld controller to select and move the stick once it has been picked up. In one example, the EEG controller or other devices that can allow transforming biometrical parameters into game commands may be used to determine a likelihood that the user will drop the stick once the user has picked the stick up and begun moving it with a handheld controller. In some arrangements, a balance board may be used to keep a stick steady while moving it. That is, if a degree with which a player's weight shifts on the balance board may determine a likelihood that the stick will move unpredictably and disturb other nearby sticks.

The Tightrope Walker: A tightrope walker game may be played with a handheld controller, a balance board and/or an EEG controller or other devices that can allow transforming biometrical parameters into game commands. In one arrangement, an EEG controller may be optional while a handheld controller may be required. Different levels and settings may be incorporated into the game to convey different levels of difficulty. For example, a rope that is suspended low to the ground may be provided as a training or introductory level while a rope suspended over a gorge may be included as an advanced level. Other types of levels or settings may include, a tower tightrope (e.g., suspended between multiple towers or between elements of a single tower), a utility pole wire (e.g., between utility poles), a circus tightrope and/or a precarious bridge tightrope. The game may require the user to traverse a tightrope while maintaining balance (since the tightrope is generally characterized by some level of instability) so as not to fall off. The game may be played in both single and multiplayer formats. For example, in multiplayer format, the players may compete to see who is able to cross the tightrope first without falling. With a handheld controller, a user may move an avatar using directional keys while maintaining balance by keeping the controller steady (e.g., minimizing trembling, tilting or other movement of the controller beyond depression of keys). The game may also be played using an in which balance is maintained by measuring the relax parameter to balance and movement is achieved using an attention parameter. Further, a balance board controller may be used to measure a player's balance (e.g., shifts in weight) and to move. For example, movement may be achieved by rocking the board forward and backward while balance is maintained by minimizing side to side shifts.

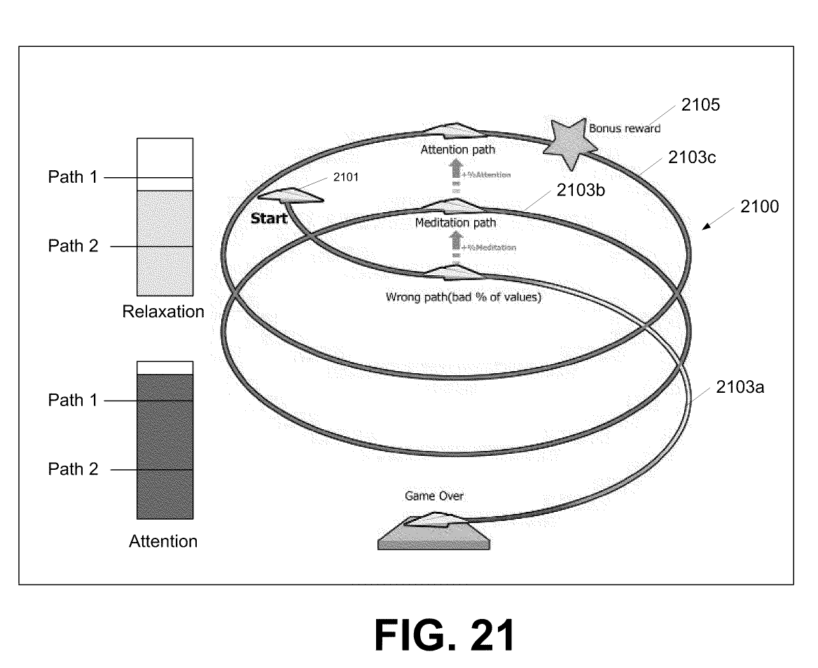

Origami: An origami game may include an origami object or other object that is animated as flying within an environment. Using the player's mental or physical attributes, the player must keep the object in flight. FIG. 21 illustrates an example of an origami flight game 2100 in which a paper airplane 2101 may fly along multiple paths 2103. The path along which airplane 2101 flights may depend on the player's attention parameter and relax parameter measurements. For example, if both attention and relax are below a specified threshold, plane 2101 may follow path 2103a. If, however, the player's relax parameter is above the threshold, plane 2101 may follow path 2103b. If the player is also able to maintain his or her attention parameter above the threshold, plane 2101 may be able to achieve path 2103c. The thresholds for the attention and relax parameters may be different or the same. Bonus items 2105 may be placed in various portions of the paths to provide motivation for the player to reach path 2103c. In some examples, bonuses may be placed in different levels 2103 to train the player's control of his or her mental faculties (e.g., be able to lose and regain attention at will). In some arrangements, an EEG controller or other devices that can allow transforming biometrical parameters into game commands may be required. Additionally or alternatively, the game may include interface elements 2107 to convey a player's current level of relaxation and attention. For example, elements 2107 may comprise batteries or other types of gages. Elements 2107 may further include a threshold indicator to identify a level that must be reached to move airplane 2101 to a particular flight path.

Brain ball: The object of brain ball is to move a ball toward another player's avatar. The players' avatars may be positioned across from one another at a virtual table and the players may compete to move the ball toward the other or toward themselves. The power of drawing a ball closer or pushing the ball away may depend on the level of attention and relaxation the player exhibits and as detected by an EEG controller or other devices that can allow transforming biometrical parameters into game commands. In some arrangements, goals may be displayed at each end of the table and the game may set the objective to moving the ball into the opponent's goal. Alternatively or additionally, players may take turns controlling the ball rather than struggling against one another to control the ball. Attention may be used to move the ball forward while relaxation may be used to move the ball side to side. This game may require the use of an EEG controller or other devices that can allow transforming biometrical parameters into game commands to play.

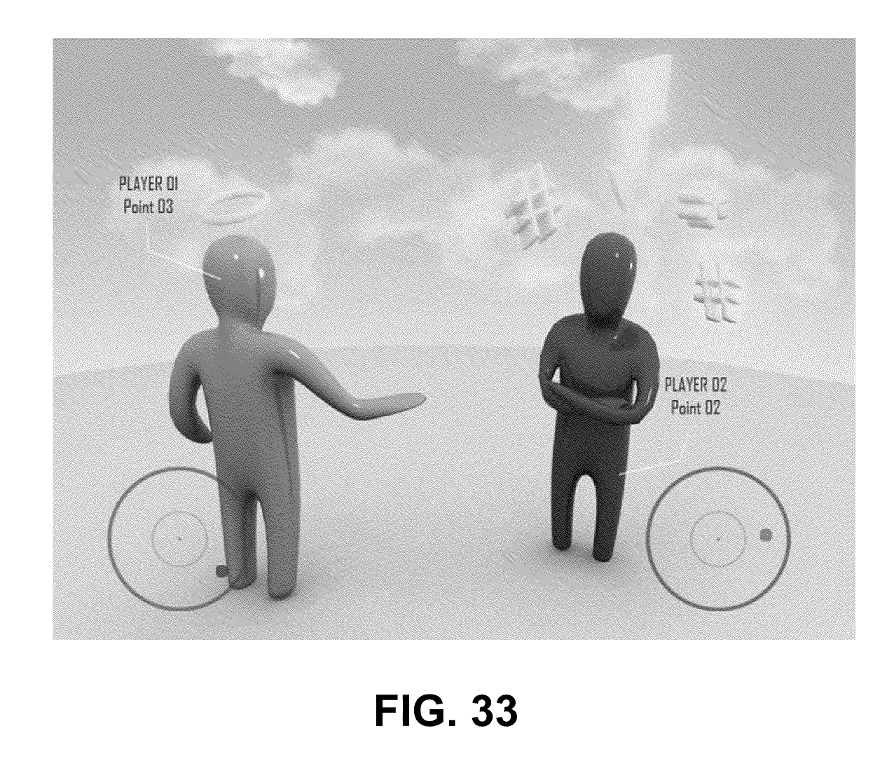

Fair play: the game consists of a sort of “battle-of-words” between two opponents on the basis of a specific subject. The two opponents are called the “teaser” and the “tolerant” (the recipient of the other's teasing). The system proposes a subject of discussion: the “teaser” shall virtually “hit” the opponent (the “tolerant”) and make the “tolerant” lose its self-control/patience. The basic idea includes creating a game similar to a boxing-match but, instead of punches, to use words and mental-control. As in traditional boxing, the game may include 4 rounds lasting 3 minutes each, with a pause of 1 minute between each round. After completing a round the opponents switch roles and controllers: for example, the person wearing the EEG controller or another device that allows the detection and transforming of biometrical parameters into game commands plays the “tolerant” role and the other player plays the “teaser” role. At the beginning of each round the “Teaser” must pick the subject of the discussion (different proposed subjects are displayed as icons above the tolerant's “virtual” head). If the relaxation level of the “tolerant” goes below a preset threshold, it game may determine that the “teaser” has dealt a good blow gaining a specified number of points. If the relaxation level is close to zero (or very low) or below a predefined threshold, the tolerant may collapses and a countdown may begin. If after ten seconds the tolerant's relaxation level doesn't rise above the predefined threshold (or another threshold), the teaser wins the match for technical knockout. If at the end of the match (4 rounds) there is a tie, there may be an extra round based on a free subject. In one example, the game may continue until one of the players loses two consecutive times. FIG. 33 illustrates an example fair play gaming interface.

“One Shot One Kill”: This game corresponds to a game mode of the fair play game as described above. It is similar to the standard match, with the following differences: 1) only one round for each player; 2) the players have only one available life in each round (no points, player loses a life when hit); 3) if the players tie an extra round without time limit will be played

A third mode of the Fair Play game is The Battle. This game mode is similar to “One Shot One Kill” mode with the following difference: each player wears an EEG controller or other devices that may be configured to transform biometric parameters into game commands and to measure mental attributes in real-time. The game may be turn-based and may propose a random subject to begin each round or game. Each contender, one at a time, starts to agitate or raise the stress level of the other on that subject, trying to raise the opponent's stress level to a threshold level. The players may be represented by avatars in the game performing various actions (e.g., hitting the other user with weapons or mind powers). In one or more arrangements, the game might not enforce time limits.

To prevent the tolerant from raising his or her relaxation level without being focused on the game, the attention parameter may be monitored to insure that it does not fall below a certain level. If the attention parameter does fall below the specified level, the Tolerant player may receive penalties (e.g., deduction in points per second, deduction of a number of points if the player's attention is diverted for a total of 15 seconds). Additionally or alternatively, the Tolerant player may be disqualified if his or her attention falls below a level.

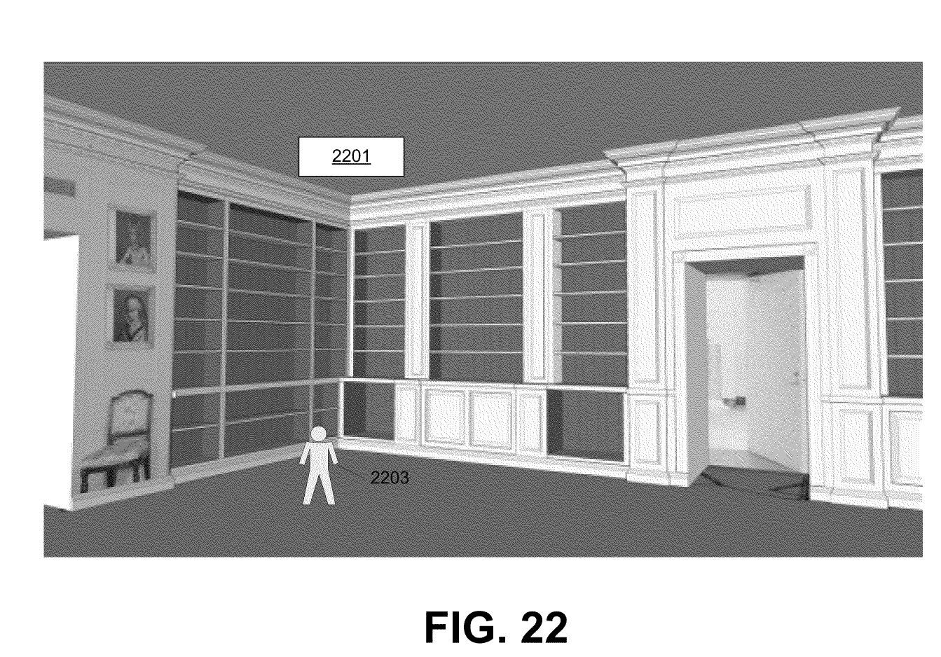

Optionally, a relaxation game or program may include an interface displaying various types of information about disciplines, exercises, medical and non-medical treatments, vacation spots and the like. For example, information may be provided about a history of a discipline, current practices, postures/exercises, overviews, goals and benefits, disclaimers, flower therapy, herbal infusions, color therapy and visualizations. In one example illustrated in FIG. 22, the knowledge menu may comprise a virtual 3-D library 2201 in which the player may move around with or without the assistance of a tutor 2203. The tutor 2203 may be configured to explain different sections of the library, different interactive options, provide commentary on various topics and the like. For example, in 3-D library 2201, each book or document may comprise a theme or information topic. Interactions may be performed using a handheld controller or an EEG controller (e.g., pick locks, open/flip through books, etc.).

Brain Music: the strength of this game is in the possibility to create music and graphic effects animations simply using the powers of the mind. The idea is to physically “watch” and “listen” to your brain activity. Each brain frequency will be transformed in to musical notes and animations on the screen. The game may start with the selection of a set of virtual instruments with which you will play the “mental” music. The intensity will vary according to your relaxation parameter. The bigger your brain power is the more you will be involved in this “brainwave symphony”. Interactions may be performed using an EEG controller or other devices that can allow transforming biometrical parameters into game commands.

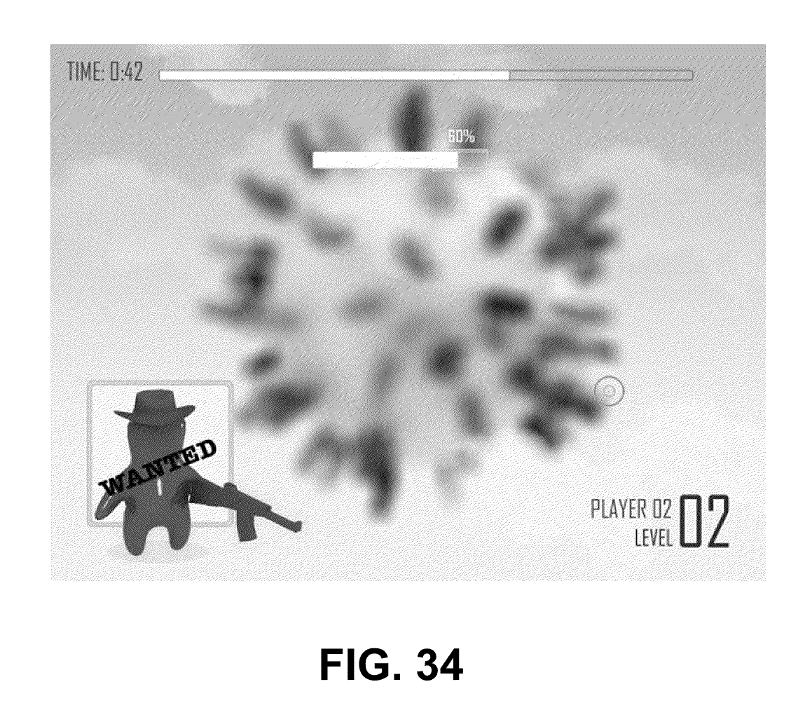

Wanted: this game may be played both in single player and in multiplayer mode. The game may include a planet where multiple animated characters exist on a surface thereof. However, one of the animated characters corresponds to a fugitive and is in hiding. Using the power of concentration the players are instructed to find the fugitive in the crowd! The game starts with a foggy screen in which the player can hardly distinguish the different elements. Therefore the only way to clearly see and begin to discern the animated characters (and thereby find and identify the “wanted” character) is by raising the “concentration” level. At the same time the player may rotate the planet, using the controller analog stick. To find the fugitive the player needs to keep its “concentration” as high as possible and for as long as possible before a predefined amount of time ends (e.g., 90 seconds). FIG. 34 illustrates an example gaming interface providing the wanted game.

Bridge Master: in this game the player must use strategy to build a bridge and reach an object such as a tower on the other side of the bridge. The game may be played in single player mode or in multiplayer mode. The players may start from different towers and be required to reach the opponent's tower. In order to do that, they may be required to build a bridge with their brain power, lifting and moving blocks from the terrain. The gameplay is simple and stimulates the competition between the players. They will have to select the area they want to conquer, anywhere in the field, and by using the concentration parameters they will lift the block to the area. Once an area has been conquered by a player (e.g., a player has already built a portion of a bridge in that area), the same can no longer be selected by his opponent. Players may choose a box to build their way to the target tower or choose to build obstacles for the opponent. Players can select the same free box at the same time but only one of them in the end can conquer it. In one or more arrangements, the only parameter factored into building may be “concentration”, e.g., the more a player is concentrated, the less time required to lift and move a block to a desired area. There may be 6 levels and difficulty will be increased by the relative positioning of the towers.

Gravity: The game takes place in a white limbo with a spherical object positioned in the centre. This object is a world inhabited by little creatures that live one next to the other, thus covering the entire surface. The problem is that this world doesn't have gravity and its inhabitants tend to separate and float into space. The aim of the game is to make sure these creatures remain on the planet. The player has to maintain a high level of concentration so that the inhabitants of the planet remain firmly on the ground. Despite the player's efforts, if the level of concentration declines, some of the creatures could detach from the group and start floating into space. The player has to use the standard controller to catch them and bring them back to earth, first selecting them and then dragging them down. If the player is not fast enough, the little inhabitants tend to float out of the screen and subsequently it will be impossible to recuperate them. The game starts with a set number of inhabitants on the planet. The game consists of 5 levels (max 5 minutes time length each) and one level after another: (a) the difficulty increases; (b) the gravity decreases (and the “battery” discharges faster); (c) the number of inhabitants to save increases. If the player doesn't save all the inhabitants within the time limit the game will be over (the number of still surviving inhabitants is displayed on the screen during the game).

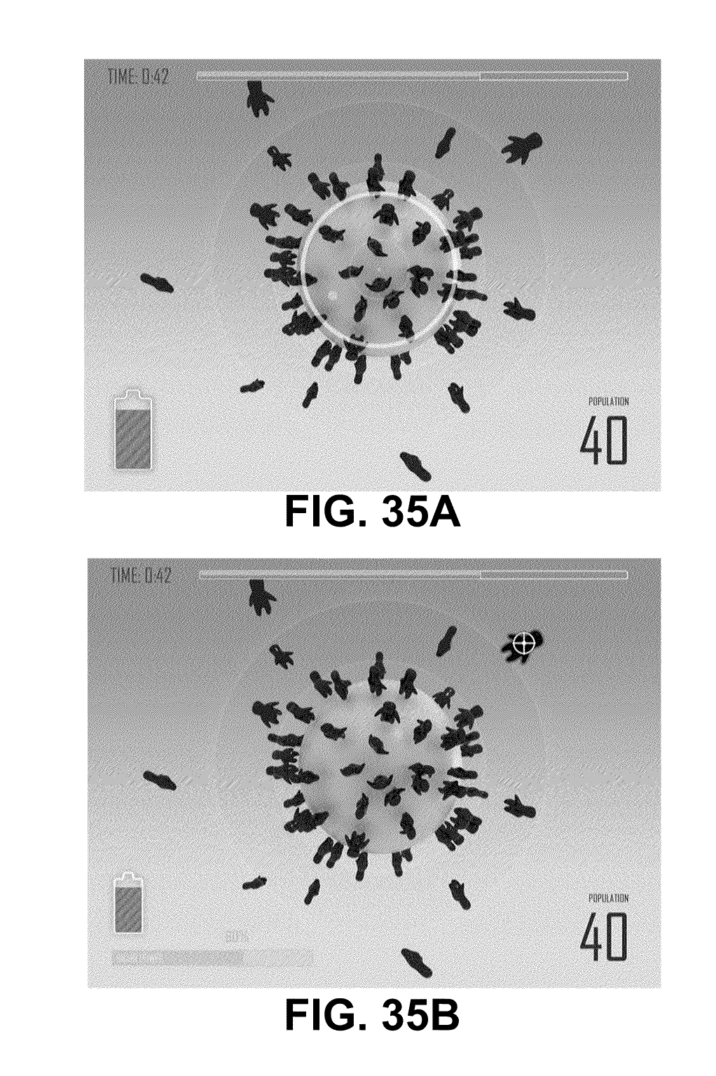

FIGS. 35A and 35B illustrate example game interfaces for the gravity game. In the game, a level of gravity may be represented by a “planet battery level indicator.” As battery discharges, while the time is passing, the gravity force decreases. Once the battery level reaches 10% the system notifies the player to recharge the battery (15-20 seconds time-limit to recharge). The method of recharging the battery may depend on the controller used. For example, a EEG or other biometric monitoring device may be used to recharge the battery by maintaining concentration above a specified level for an indicated time. The higher the concentration level the faster the battery will charge. Using other controllers such as a button based controller, a player may be required to keep a marker on a target displayed on the screen. The marker may keep moving in a random way compensating the player's movement as indicated in the training mode. Once completed the “charge the battery” phase, the game consists of catching the inhabitants that keep escaping from the planet surface. In this phase the player may use the button based controller to select and pull back the inhabitants on the surface. The multiplayer mode works like the single player mode but in this case the displayed worlds are two (in some cases, in the same screen, i.e., not split screen) each one with inhabitants of different colours. To play the players can both use biometric monitoring controllers, classic button based controllers or combinations thereof. When an inhabitant escapes from its planet surface it starts to float “in the space” exiting the first planet orbit. If the second planet (so, of the second player) gravity is higher than the first planet gravity (so, of the first player) then the floating inhabitant can be caught by the second planet gravity finally becoming an inhabitant of the second planet.

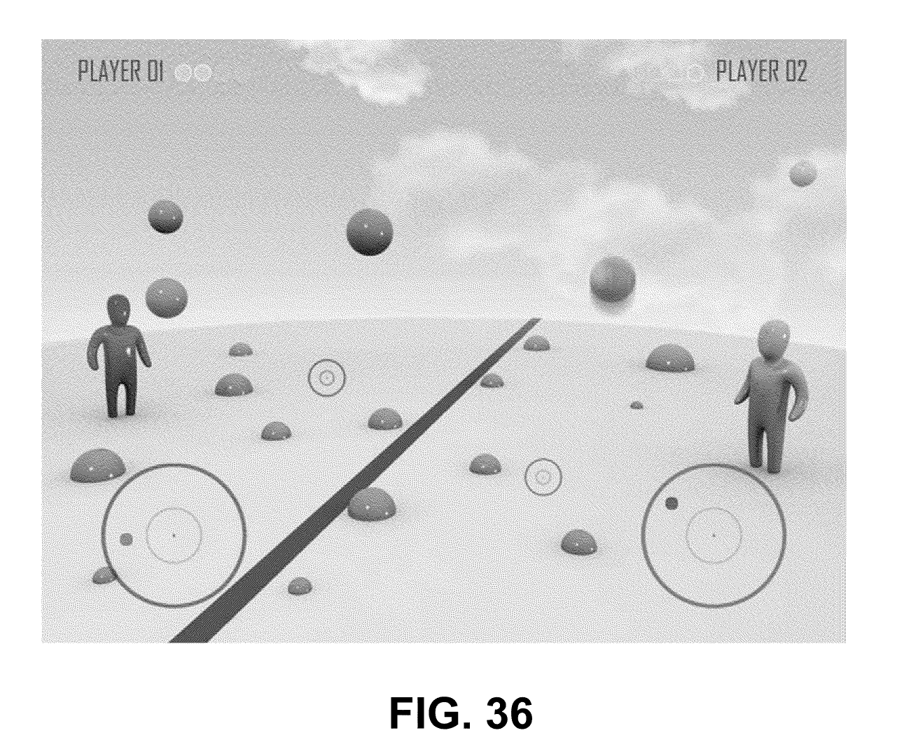

Mudd Battle: similar to handball, the game is set on a tennis court and the two players are facing each other surrounded by coloured spheres. FIG. 36 illustrates an example game interface. In a first instance the players may be required to concentrate to lift as many spheres as possible, the more they are concentrated the more spheres they will manage to lift. After that first phase, the players will throw their spheres using their controllers in an attempt to hit the opponent. The game result is therefore affected by the combination of brain power and shot accuracy, making it always different and enjoyable. The game is a sequence of two different phases. In first instance the player lifts, according to his concentration parameter, from a minimum of 1 to a maximum of 6 spheres in the given time (e.g., 30 sec). Then, in the second phase, the player may select the spheres he or she managed to lift and, with the button or hand controller, shoot them one at a time against the opponent in an attempt to hit the opponent. The player may be able to move around trying to dodge the flying spheres. For example, the player may move to the left or right trying to dodge the flying spheres. Every hit corresponds to 1 point, the player who achieves more hits during the 3 minutes gaming session wins. Alternatively or additionally, a player may have a number of “lives,” that are taken away each time the player is hit. Accordingly, once a player's last life is taken away, that player may be declared the loser and the other player declared the winner.

Brain Garden: Brain Garden is a virtual garden that you look after personally, making it grow and flourish. According to your concentration and relax levels, growth will be more florid or drier and more withered. The game allows a player to generate and grow grass, flowers and fruit, following its development and regeneration day by day. However, abandoning the garden for too long (e.g. a predefined amount of time) may cause the garden to suffer due to lack of care and wither. The game may allow the player to review a growth cycle to see what happened and study the life cycle that the player's brain waves produce. Additionally, the game allows the player to observe how time passes, how seasons change, weather conditions based on the player's attributes and interactions. The game parameters may include concentration and relaxation. In some arrangements, a classic button controller might only be used to select the items in the garden. Other than the selection, the player might only use passive input or biometric input to control the elements of the game.

In FIG. 11 if a player selects Workbook option 1107, the user may be presented with all statistics about the player's training progress. For example, the player may review all measured statuses as well as training status. A workbook may also be accessible through statistics option 1107.

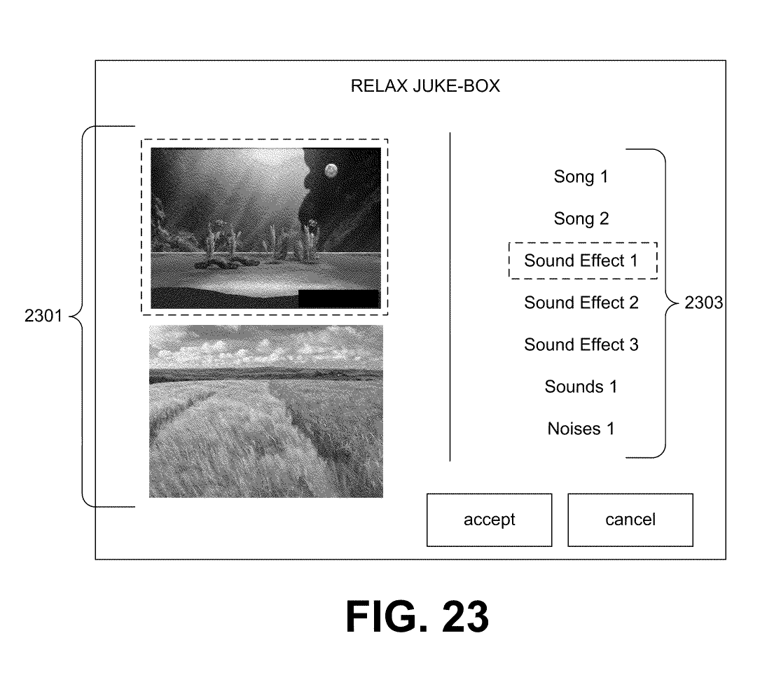

Additionally, if a player selects Relax Jukebox option 1109, a user may be provided with a menu of screensavers and/or relaxing sound tracks. For example, FIG. 23 illustrates an example Relax Jukebox selection menu 2300 from which a user may select a desired screensaver (e.g., a set of images, animated images, video) from list 2301 and from which a user may select accompanying audio from list 2303. In one example, Relax Jukebox selection menu 2300 may include screensavers such as an ocean, green fields, clouds, mountains and sands and audio such as relaxing soundtracks and sound effects (e.g., ocean sounds, crickets, wind sounds, Tibetan gongs, beach sounds); audio may automatically be associated to specified videos and photos by the gaming system device. According to one or more aspects, a player may also be able to create his or her own playlist for a screensaver. For example, the player may select songs and define an order of the songs for play during the display of the screensaver images or video. A tutor may also suggest specific songs, song categories, artists and the like for creating the playlist. These suggestions may be based on previous user selections, type of music (e.g., soft rock vs. hard rock) and the like and on the basis of relaxation level measured by an EEG controller or other devices that can measure and monitor biometrical parameters.

With reference to FIG. 11, a user may access a Quick Training menu through option 1111 to directly access a particular discipline and/or exercise. The selection of Quick Training option 1111 may result in a menu comprising a mini-training programs option (not shown) and a disciplines option (not shown). Mini-training programs option may comprise a predefined set of exercises and/or activities for a one day training program corresponding to a daily goal. The daily programs may be generated in similar fashion to a full training program that stretches for multiple days, weeks or months. These daily programs may be divided into multiple categories. For example, a body training game may include mini-training program categories such as active, relax, balanced and kids. Mind mini-training program categories, on the other hand, may include mental stability, mental growth, mental strength and kids. In some arrangements where a player has selected a guest profile, a player may be taken directly to the mini-training programs menu (since guest profiles might not be persistent, players selecting a guest profile might not have the ability to save full training program data).

Alternatively, if a user selects a disciplines option (not shown), the player may be presented with multiple types of disciplines from which exercises may be selected. For example, disciplines may include yoga, massage, Tai-Chi, Qi Gong, Pilates and progressive muscle relaxation. If the game is directed to mind training, on the other hand, the disciplines may include meditation and breathing, autogenic training, visualization and binaural beats.

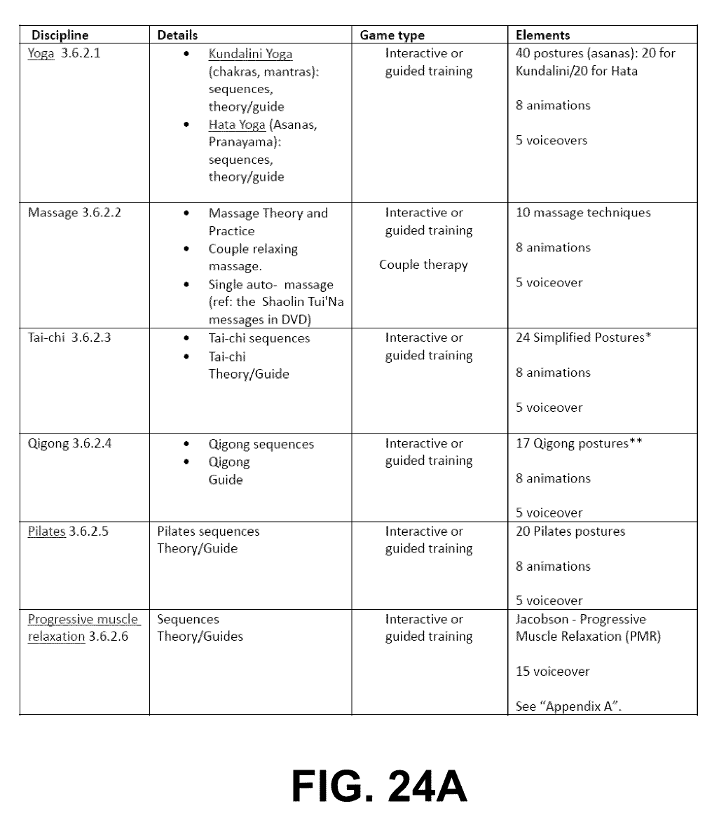

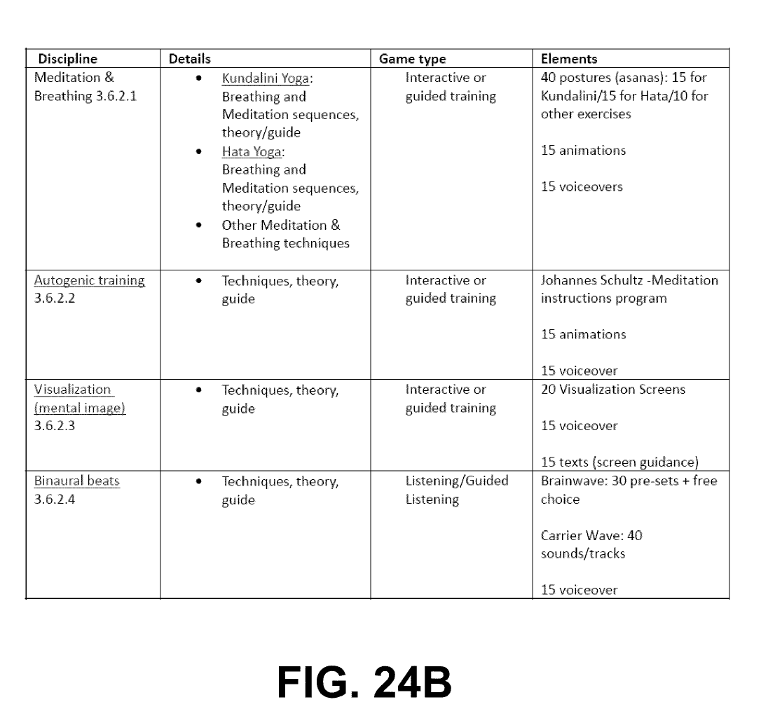

FIGS. 24A and 24B illustrate and describe the various disciplines for body and mind, respectively, and training or game elements thereof.

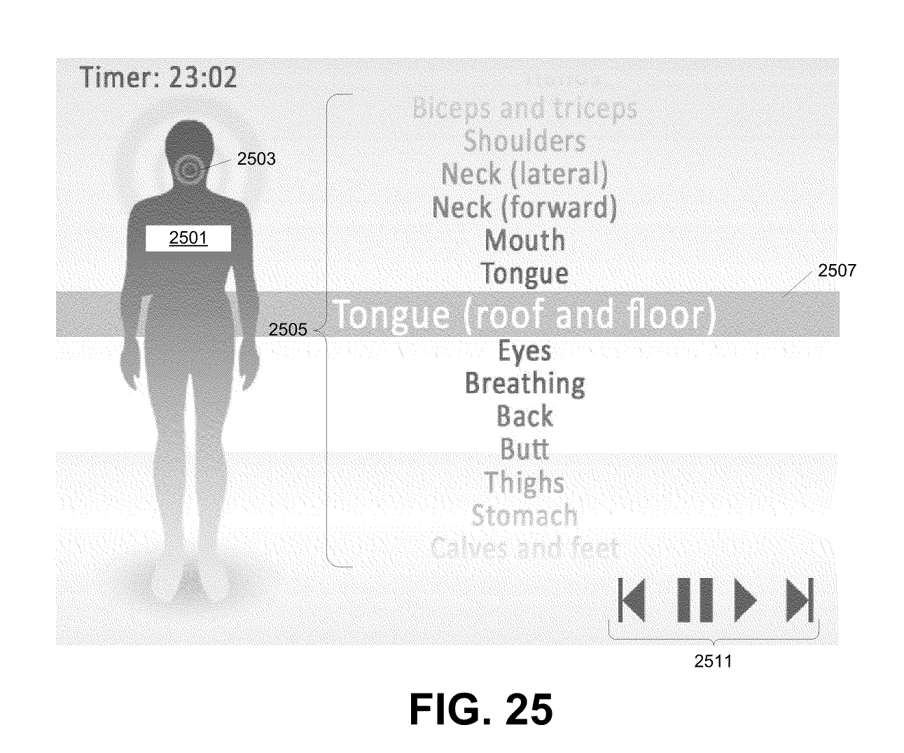

FIG. 25 illustrates an example interface for progressive muscle relaxation training. Interface 2500 includes the picture of a human body 2501 along with an indicator 2503 that identifies the region that a player is instructed to relax. Interface 2500 may further include a list of body parts 2505 and a highlight or focus bar 2507 identifying the body part being currently trained. The body part 2509 on which highlight bar 2507 is currently focused may correspond to the location identified by indicator 2503 on body 2501. A player may control the training by skipping or fast forwarding, reversing, playing and pausing the training program using options 2511. In some arrangements, voice over effects may be added.

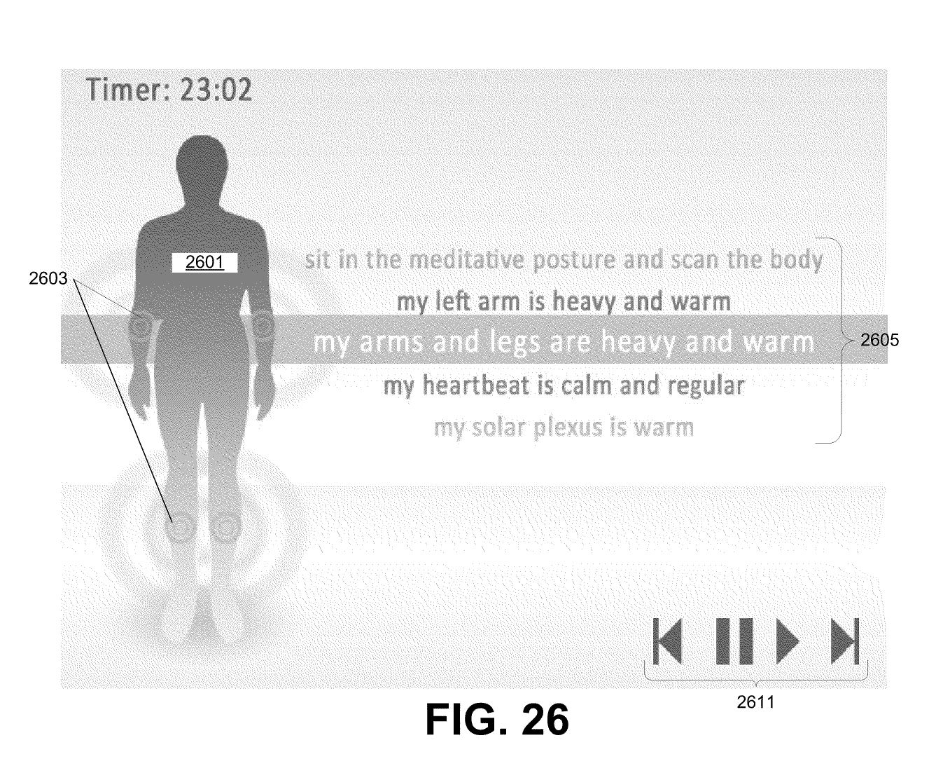

FIG. 26 illustrates an example autogenic training interface in which a player visualizes the conditions displayed. For example, interface 2600 may display a picture of a human body 2601 along with indicators 2603 identifying various parts of the human body 2601. Interface 2600 further includes a list of conditions 2605 that the use is to visualize (e.g., pretend is occurring). As with interface 2400 of FIG. 24, indicators 2603 may track the body part corresponding to the current visualization condition and options 2611 may be used to control the progression and speed of the training. In some arrangements, voice over effects may be added.

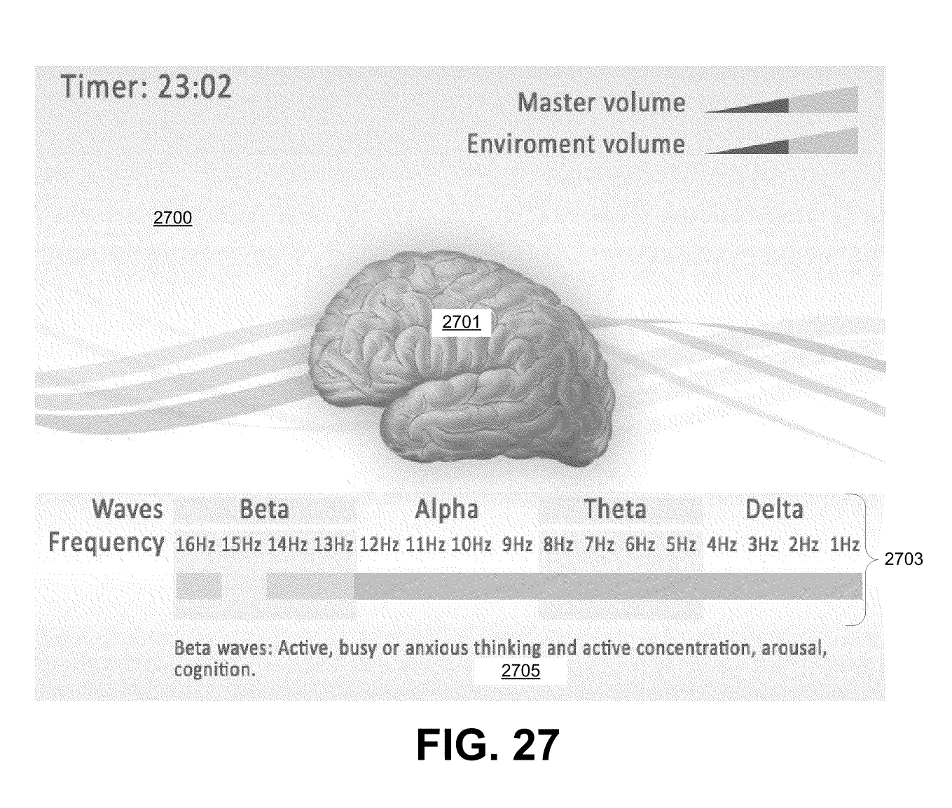

FIG. 27 illustrates an example binaural beats training interface. In interface 2700, a picture of a brain 2701 may be displayed along with a scale of brainwave frequencies 2703. Using an EEG controller, for example, the game or training program may play binaural beats to the player to modify the brainwaves being generated by the player. The detected frequency of brainwaves may then be identified on scale 2703. Additionally, messages and information relating to each zone of frequency waves (e.g., beta, alpha, theta and delta) may be displayed in portion 2705 to help the user understand his or her current state.

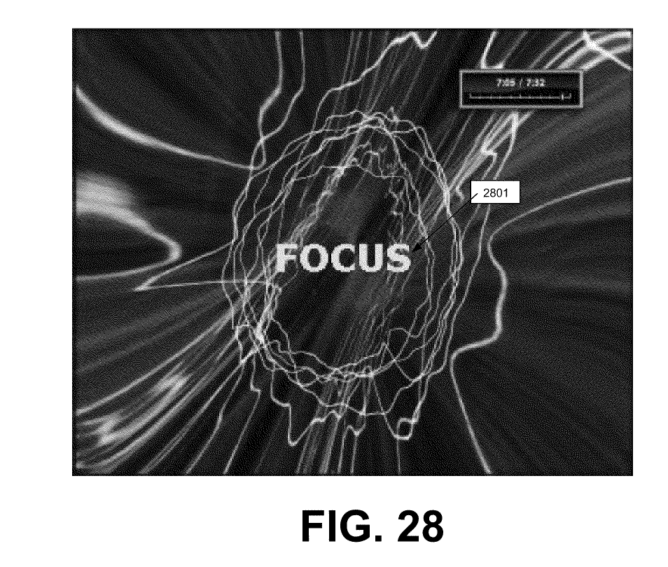

FIG. 28 illustrates an example visualization training interface 2800 in which words and messages such as word 2801 may be displayed while a player is asked to focus on the patterns configured to relax the mind. The visualization may be accompanied by audio components such as a playlist, binaural beats and/or voice-overs keyed to the text displayed, e.g., word 2801. If a player chooses to keep his or her eyes closed, the game might not display words or messages or a visualization pattern since the player would not see them anyways. Instead, the game may display a background and play audio components.

As described herein, aspects of training programs and video games may involve the use of an EEG controller or other devices that can measure, monitor and transform biometrical parameters. These devices can measure different parameters as heart pulse, blood pressure, blood oximetry, eyes blinking. Each one of these parameters may be interpreted to calculate the player's relaxation and concentration level. Furthermore, an EEG controller may be configured to capture or detect two brain states, Relaxation (or Meditation) and Attention (or Focus). The values of each of these measurements or states may be generated or converted to a scale from 0 to 100. As noted herein, using relaxation and attention, various aspects of a game may be controlled. Using the 0 to 100 scale, a detected value between 30 to 50 at any given moment in time may be considered “neutral” and is similar in notion to “baselines” that are established in conventional EEG measurement techniques. A value from 50 to 70 may be considered “slightly elevated,” and may be interpreted as levels being possibly higher than normal (levels of attention or relaxation that may be higher than normal for a given person). Values from 70 to 90 may be considered “elevated,” meaning they are strongly indicative of heightened levels of that parameter and values from 90 to 100 may be considered “strongly elevated,” indicating unusual or abnormally high levels of that parameter. Similarly, on the other end of the scale, a value between 10 to 30 may indicate “lowered” levels of the parameter, while a value between 1 to 10 may indicate “strongly lowered” levels of the parameter. These levels may indicate states of distraction, agitation, or abnormality, according to the opposite of each parameter. In one or more arrangements, a parameter meter value of 0 is a special value indicating the device is unable to calculate a parameter level with a reasonable amount of reliability. This may be due to excessive noise.

An attention (or focus) parameter may be indicated by an unsigned one-byte value that indicates the current attention level of the user. The attention level may indicate the intensity of a user's level of mental focus such as that which occurs during intense concentration and directed, but stable mental activity. The attention meter value may range from 0 to 100. Distractions, wandering thoughts, lack of focus, or anxiety may lower the attention meter levels. An attention parameter may be measured continuously, intermittently or based on a predefined schedule (e.g., per second, per 30 seconds, per minute, etc.).

Relaxation (or meditation) may also be reported as an unsigned one-byte value. The relaxation level may indicate the level of a user's mental calmness. Relaxation may be represented by a value between a range of 0 to 100. Note that relaxation is a measure of a person's mental levels, not physical levels, so simply relaxing all the muscles of the body might not immediately result in a heightened meditation or relaxation level. However, for most people in most normal circumstances, relaxing the body often helps the mind to relax as well. Relaxation is related to reduced activity by the active mental processes in the brain, and it has long been an observed effect that closing one's eyes turns off the mental activities which processes images from the eyes, so closing the eyes is often an effective method for increasing the relaxation meter level. Distractions, wandering thoughts, anxiety, agitation, and sensory stimuli may lower the relaxation meter levels. As with an attention parameter, the relaxation parameter may be reported or measured according to various schedules. Relaxation and attention parameters will be calculated by the gaming device system on the basis of the detected biometrical levels and values.

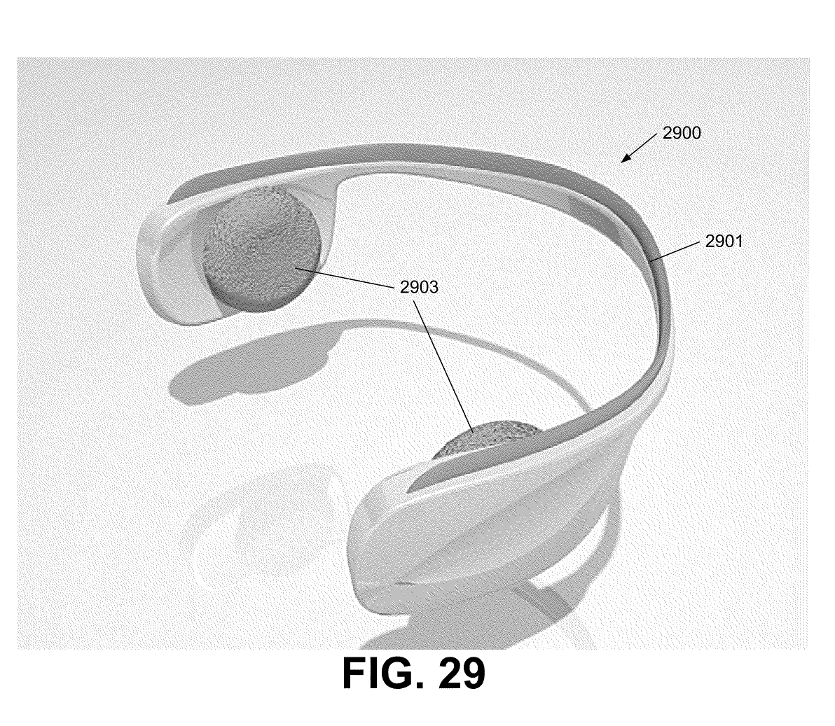

FIG. 29 illustrates an example EEG controller headset. Headset 2900 may include various components including a headband 2901 configured to wrap around a person's head and audio input/output devices 2903 (e.g., earphones with microphone). Band 2901 may include one or more EEG sensors to detect brain activity. In the illustrated example, the EEG sensors are hidden within band 2901. In one or more arrangements, headset 2900 may further include other input devices such as a microphone. Headset 2900 may also include haptic or tactile feedback devices such as a vibration device. More information about EEG headset design and operation may be found at http://openeeg.sourceforge.net/doc/, of which the entire web site (including source code, object code, instructions, videos, presentations, documentation, etc.) is herein incorporated by reference for all purposes.

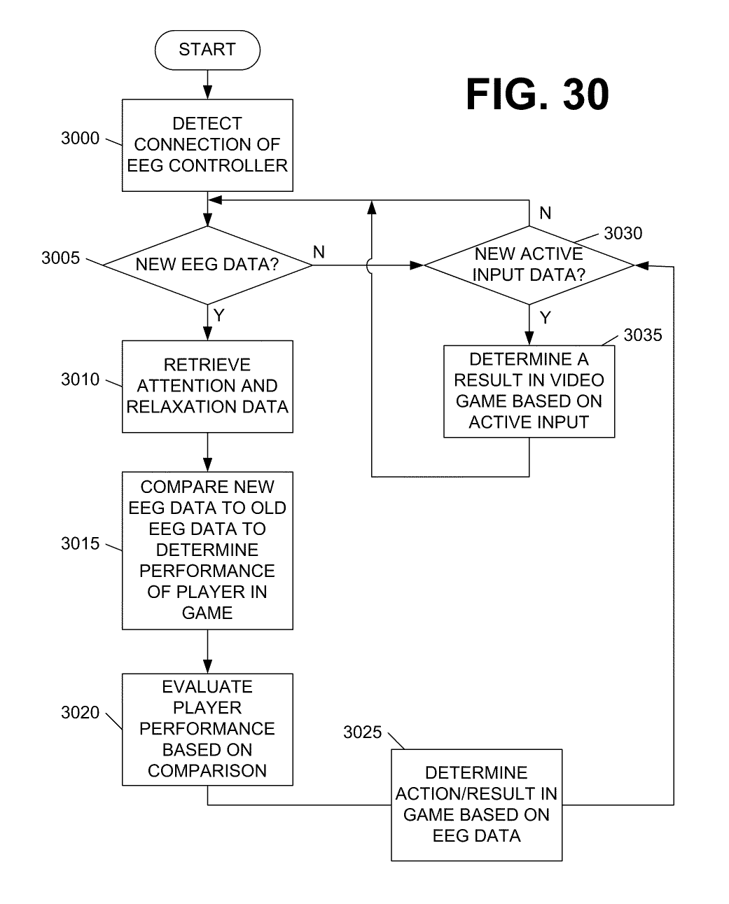

FIG. 30 is a flowchart illustrating a method for receiving and processing data from an EEG controller. For example, in step 3000, a game system may detect the connection of an EEG controller. For example, the game system may receive alert messages from the EEG device indicating its existence. Additionally, the game system may recognize that the connected device is an EEG device based on information communicated from the EEG device such as a product model number, capabilities information, measured data and the like. In step 3005, the game system may monitor for EEG data and determine whether new EEG data is available. For example, the EEG controller may send an indication to the game system each time new EEG data is available. If new EEG data is available, the game system may retrieve attention and relaxation parameter data from the EEG controller in step 3010. The new EEG data may then be compared to a history of player EEG information to evaluate player performance in step 3020 and to determine an outcome or result in the video game in step 3025. For example, a game system may determine whether a player's previous EEG measurements are lower than the new parameter data. If so, the player may awarded a number of points for improving his or her EEG measurements (e.g., better attention or relaxation). Additionally, the level of a player's relaxation may affect a game element such as a strength of a power or a speed of movement.

Additionally, the video game system may determine whether new active input data is available in step 3030. Active input data may comprise information that is generated as a result of player movement (e.g., body, a limb, eyes, mouth, etc.) while EEG data and other passive input does not require physical action on the part of the player. If active input data is available, the video game system may further determine a result or consequence in the video game based on the active input in step 3035. In some arrangements, passive input may affect the in-game result of active input and vice versa.

One or more aspects described herein may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

In addition, the description includes one or more inventions that may be used alone or in combination with each other. For example, the electroencephalography (EEG) headset may be used with the below described games and software, or with other games and software. The headset may be used with any game console, computing device, server, digital video recorder (DVR), mobile device, networked device, etc. The individually described games may be playable with or without the EEG headset, and may be played in different manners than specifically described. The below descriptions are for illustrative purposes to enable multiple embodiments of each invention contained herein. Applicant reserves the right to pursue each invention individually or in combination with one or more other inventions described herein.

Additionally or alternatively, a relaxation and/or attention level of a player may be measured in other ways using other devices (e.g., other than an EEG device). For example, a player's pulse may be measured to determine a level of anxiety and/or focus. In another example, a player's body temperature may be monitored and correlated to relaxation and/or attention. In another example, a pulse oximeter may be used to determine the player's level of relaxation and stress or used to measure other biometrical parameters.

Although the subject matter has been described in language specific to structural features and/or methodological acts, it is to be understood that the subject matter described herein is not limited to the specific features, embodiment, aspects, or acts described. Rather, the specific descriptions herein are provided as example and illustrative forms of implementing one or more aspects of the invention.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
receiving, by a video game system, passive player input corresponding to at least one of: a mental attribute and a physical attribute of the player from a first control device comprising a monitoring device configured to measure biometric attributes of the player;
receiving, from a second control device, active player input corresponding to movement of at least a portion of the player;
determining at least one of a level of relaxation and a level of concentration of the player based on the passive player input;
controlling a first element of a video game based on the determined at least one of the level of relaxation and the level of concentration; and
controlling a second element of the video game based on the active player input.

2. The method of claim 1, wherein the video game includes a training program configured to increase the level of relaxation of the player.

3. The method of claim 1, wherein the monitoring device includes an electroencephalograph device configured to measure electrical impulses generated by the player's brain

4. The method of claim 3, wherein the electroencephalograph device comprises a microphone configured to receive voice input from the player.

5. The method of claim 1, wherein the active player input corresponds to the pressing of a button of the second control device.

6. The method of claim 1, wherein the active player input corresponds to a detected motion of a second control device.

7. The method of claim 1, wherein controlling the second element of the video game further includes:
translating the active player input into a first action in the video game when the determined at least one of the level of relaxation and the level of concentration is above a threshold; and
translating the active player input into a second action in the video game when the determined at least one of the level of relaxation and the level of concentration is below the threshold.

8. The method of claim 1, further comprising determining that the level of relaxation is below a threshold, wherein controlling at least one element of a video game is performed in response to determining that the level of relaxation is below the threshold and includes causing an interface of the video game to display an instruction configured to relax the player.

9. The method of claim 1, wherein the first control device is configured to be coupled to the second control device and wherein the passive input from the first control device is communicated to the video game system through the second control device.

10. The method of claim 1, wherein the video game comprises an avatar battling one or more entities and wherein the first element corresponds to the use of an offensive power by the avatar and the second element corresponds to movement of the avatar.

11. The method of claim 1, wherein the video game comprises controlling a level of gravity on a virtual planet and wherein the first element corresponds to the level of gravity and the second element corresponds to a position of one or more virtual characters associated with the planet.

12. The method of claim 1, wherein the video game comprises a plurality of objects configured to be thrown at an opponent, wherein the first element corresponds to a number of objects activated for throwing and wherein the second element corresponds to a direction that at least one of the objects is thrown.

13. The method of claim 1, wherein the video game comprises a plurality of characters and wherein the first element corresponds to a clarity with which the plurality of characters are displayed.

14. The method of claim 1, wherein at least one of the first and second control devices comprises a video capture device configured to capture images.

15. A method comprising:
receiving, by a video game system, passive input from a control device, the passive input including biometric readings of a first player detected by the control device;
determining a level of relaxation of the first player, wherein the level of relaxation corresponds to a calmness of the first player;
determining a level of attention of the first player, wherein the level of attention corresponds to an intensity of focus of the player;
modifying a first element of the video game based on the determined level of relaxation of the first player; and
modifying a second element of the video game based on the determined level of attention of the first player.

16. The method of claim 15, wherein the video game comprises directing an airplane on a flight path, wherein modifying the first element of the video game comprises elevating the airplane to a first flight path and wherein modifying the second element comprises elevating the airplane to a second flight path.

17. The method of claim 16, wherein the first flight path is higher than the second flight path and includes one or more bonus items.

18. The method of claim 15, wherein the video game comprises propelling a virtual object, wherein the second element corresponds to a speed of the virtual object and the first element corresponds to another game parameter configured to affect the distance that the virtual object is propelled.

19. The method of claim 15, wherein the video game comprises a target shooting game and wherein the second element corresponds to a force with which a projectile is launched and the first element corresponds to a location on a target hit by the projectile.

20. A method comprising:
receiving, by a video game system, passive input from a control device for a video game, the passive input including biometric readings of a first player detected by the control device;
determining a level of relaxation of the first player, wherein the level of relaxation corresponds to a calmness of the first player;
determining a level of attention of the first player, wherein the level of attention corresponds to an intensity of focus of the player;
determining an amount by which a video game avatar of the first player is adversely affected based on the determined levels of relaxation and attention; and
in response to determining that the amount is above a specified level, awarding a second player a number of points.

21. The method of claim 20, wherein the amount by which a video game avatar is adversely affected increases as the determined levels of relaxation and attention of the first player decreases.

22. The method of claim 20, wherein the number of points awarded to the second player is determined based on an amount of time lapsed from a beginning of the video game to a time at which the amount by which the first player's avatar is adversely affect exceed the specified level.

23. The method of claim 20, wherein the second player is awarded the number of points each time the amount by which the first player's video game avatar is adversely affected exceed the specified level and wherein a total score for the second player is determined based on a total number of points awarded over a specified time period.

24. The method of claim 20, further comprising displaying, by the video game system, a topic for discussion, wherein the first player's level of attention and level of relaxation is affected by a discussion of the topic.

25. The method of claim 20, wherein the amount by which the first player's avatar is adversely affected only exceeds the specified level when the determined level of attention is below a first threshold and the determined level of relaxation is below a second threshold.

26. The method of claim 20, wherein the biometric readings include electroencephalograph readings.

27. The method of claim 20, wherein the biometric readings include pulse oximetry readings.
